(19) United States
(12) Patent Application Publication
(10) Pub. No.: US 2024/0383821 A1
(43) Pub. Date: Nov. 21, 2024

(54) LIQUID FOLIAR COMPOSITION

(71) Applicant: Omya International AG, Oftringen (CH)

(72) Inventors: Nora MÜLLER, Bern (CH); Fabrizio ORLANDO, Würenlos (CH); Joachim SCHOELKOPF, Oberkulm (CH); Gabriela MELO RODRIGUEZ, Aarau (CH); Victoria FERNANDEZ, Madrid (ES)

(73) Assignee: Omya International AG, Oftringen (CH)

(21) Appl. No.: 18/722,397

(22) PCT Filed: Dec. 27, 2022
(86) PCT No.: PCT/EP2022/087882

§ 371 Date: Jun. 20, 2024

(30) Foreign Application Priority Data
Dec. 27, 2021 (EP) 21217833.9

(51) Int. Cl. C05G 5/27; A01C 21/00; C05D 3/02; C05D 9/02; C05G 3/50

(52) U.S. Cl. CPC C05G 5/27; C05D 3/02; C05D 9/02; C05G 3/50; A01C 21/00

(57) ABSTRACT

The present invention refers to a liquid foliar composition, a method of formulating such a liquid foliar composition, a method of increasing the wettability of a surface, use of said liquid foliar composition in agricultural and horticultural applications as well as the use of a particulate mineral-based material comprising at least one alkaline earth metal ion-comprising material, iron oxide or zinc oxide in a liquid foliar composition.

The present invention refers to a liquid foliar composition, a method of formulating such a liquid foliar composition, a method of increasing the wettability of a surface, use of said liquid foliar composition in agricultural and horticultural applications as well as the use of a particulate mineral-based material comprising at least one alkaline earth metal ion-comprising material, iron oxide or zinc oxide in a liquid foliar composition.

Fertilizers have long been used for improving the growth of plants or crop yield. Generally, the soil is provided with necessary components like nitrogen (urea, nitrate), phosphorous (phosphate), potassium (as a salt), sulphur (sulfate or sulfite) or nutrients. However, it has become clear that applying fertilizers on for example the leaf of plants may be advantageous, because components can be directly taken up by the plant. Furthermore, the use of fertilizers in the form of a liquid foliar composition can be advantageous because the required amount of fertilizer is locally applied in solution, preventing waste and leaching of fertilizers.

For example, US2015266786 A refers to nanocrystalline compounds containing essential nutrients have been synthesized to have effective physical and chemical characteristics, including a high contact surface area/total surface area ratio that provides maximal leaf surface contact, limited mobility and improved solubility, a net positive charge, soluble salt-forming groups, and reactive surface edges for cation exchange to release nutrient cationic ions into the water film on leaf surfaces.

WO14087202 A1 refers to a fertilizer composition wherein a nitrogen containing macronutrient is adsorbed on the surface of hydroxyapatite phosphate nanoparticles. Said fertilizer composition slowly releases the nitrogen containing macronutrient to soil.

PL404091 A1 relates to nanoparticles foliar fertilizer is a mixture of crushed minerals containing mainly calcium carbonate and magnesium carbonate. Foliar fertilizer nanoparticles comprises particulate minerals to a particle size of 500 nm to 20 μm, which are mixed in an appropriate weight ratio and distributed in powder form. Foliar fertilizer plants a nanoparticles-nutrient supplies in the size of nano- and microparticles.

IN201841016488 refers to nano Particles of Titanium Di Oxide and Silicon Di Oxide have a profound effect if applied as foliar application on plants for deriving various benefits. Preparation and application of nano-particles as foliar application for increase uptake of essential minerals both macro and micronutrients and increase the productivity. The major requirement of sustained and improved growth of the plants is achieved by the nutrient provided as fertilizer which may be of bulk fertilizers, secondary fertilizers and micronutrients applied in soil or as foliar spray depending on the environment. The application of doped titanium dioxide and/or silicon dioxide nanoparticles helps the crops to increase the uptake of minerals from the soil there is no supplement of micronutrients added to the soil or applied as foliar application. The nanomaterials when applied as a foliar spray increased the uptake of micronutrients and increase in uptake of nitrogen, phosphate, potash and silicon from the soil.

CN106064970 refers to a foliar micro-fertilizer for grapefruit plantation and a preparation method thereof. The foliar micro-fertilizer comprises the following raw materials: phosphate fertilizer, potash fertilizer, calcium fertilizer, manganese fertilizer, iron fertilizer, boron fertilizer, zinc fertilizer, selenium fertilizer, amino acid and organosilicone. The selenium fertilizer is microbial nano-selenium. Microbial nano-selenium is bioactivated selenium fertilizer. The product can provide comprehensive nutrients for flowering and fruiting, stimulate growth and development of plants, promote absorption of nutrients and plant metabolism, increase photosynthesis and chlorophyll content, enhance bio-antioxidation effect of plants and resistance to environmental stress, improve disease resistance and stress tolerance of grapefruit, prevent abscission of blossoms and fruits, reduce pathological changes of fruits, increase yield and improve quality and mouthfeel.

CN108558524 relates to multifunctional nano titanium dioxide composite foliar fertilizer, belonging to the technical field of fertilizer. The multifunctional nano titanium dioxide composite foliar fertilizer is prepared from the following components by mass percent: 5-15 percent of nano titanium dioxide, 40-50 percent of nitrogen phosphorus potassium fertilizer, 30-40 percent of micronutrient fertilizer, 0.5-1 percent of dispersant, 5-10 percent of complexing agent and 0.1-0.5 percent of surfactant, wherein the nitrogen phosphorus potassium fertilizer is prepared from the following components by mass percent: 40-50 percent of urea, 10-20 percent of ammonium chloride and 35-45 percent of dipotassium phosphate; the micronutrient fertilizer is prepared from the following components by mass percent: 30-40 percent of ferrous sulfate, 10-20 percent of zinc sulfate, 10-20 percent of copper sulfate, 15-25 percent of magnesium nitrate and 10-15 percent of calcium nitrate. The multifunctional nano titanium dioxide composite foliar fertilizer is prepared by utilizing the special photocatalytic function of the nano titanium dioxide and then compounding other foliar fertilizer components; the composite foliar fertilizer can promote the photosynthesis of green crops, can also promote the rapid absorption of other nutrient components by leaf surfaces, can also degrade the pesticide residue and other organic residues on the leaf surfaces, also has antibacterial, insect-resistant and leaf surface self-cleaning effects, and achieves the effects of strengthening seedlings, resisting diseases, sterilizing, increasing yield, improving quality, and the like.

CN111943764 refers to an agricultural soil-modified nano-calcium foliar fertilizer and a fertilizing method thereof, and particularly relates to the field of foliar fertilizers. The foliar fertilizer is composed of the following raw materials in parts by mass: potassium fulvate, urea, potassium dihydrogen phosphate, borax, calcium carbonate, chitin and trace elements, and is prepared from the following components in parts by weight: 5-10 parts of urea, 5-25 parts of potassium dihydrogen phosphate, 1-5 parts of borax, 1-5 parts of calcium carbonate and 1-5 parts of chitin. According to the invention, calcium carbonate is prepared into small-molecule particles by a high-tech nanotechnology, then the small-molecule particles are coated with chitin so as to prevent small-molecule agglomeration phenomenon and enhance the dispersity, the suspension property and the efficiency, and calcium carbonate is nanocrystallized, so that plants can immediately absorb the calcium carbonate, the calcium carbonate is convenient to apply, excessive or fat injury is not easily caused along with spraying of sunlight and water, the calcium can be effectively absorbed, and calcium ions in the foliar fertilizer can supplement calcium elements needed by plants in real time so as to greatly improve the calcium element absorption effect and efficiency of vegetation.

However, foliar compositions of the prior art suffer from several disadvantages, especially nutrients uptake is often insufficient such that the fertilizing properties are typically not very satisfactory.

Thus, there is still a need for a liquid foliar composition that leads to better fertilizing properties such as increased nutrients uptake and a long lasting effect once the composition is applied on surfaces such as plant surfaces or fungi surfaces.

Thus, it is the object of the present invention to provide a liquid foliar composition. A further object of the present invention is that the liquid foliar composition leads to better fertilizing properties once the composition is applied on surfaces such as plant surfaces or fungi surfaces. Another object of the present invention is that the liquid foliar composition provides increased nutrients uptake and a long lasting effect once the composition is applied on surfaces such as plant surfaces or fungi surfaces.

One or more of the foregoing and other objects are solved by the subject-matter as defined herein in the independent claim. Advantageous embodiments of the present invention are defined in the corresponding sub-claims.

The present invention thus relates to a liquid foliar composition comprising
a) an aqueous solvent or dispersion medium,
b) from 0.1 to 60 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.01 to 10 wt.-%, based on the total weight of the composition, of a humectant, and/or
d) from 0.01 to 3 wt.-%, based on the total weight of the composition, of a surfactant.

According to one embodiment, the particulate mineral-based material has
a) a weight-based median particle size d₅₀ value in the range from 10 nm to 10 μm, preferably from 20 nm to 1 μm, more preferably from 30 nm to 800 nm, even more preferably from 40 nm to 500 nm and most preferably from 50 nm to 200 nm, wherein particles having a weight-based median particle size d₅₀ of 1 μm are measured by the sedimentation method and particles having a weight-based median particle size d₅₀ of <1 μm are measured by the dynamic light scattering method, and/or
b) a weight-based top cut d₉₈ value in the range from 50 nm to 100 μm, preferably from 100 nm to 10 μm, more preferably from 120 nm to 5 μm, even more preferably from 130 nm to 1 μm and most preferably from 130 nm to 800 nm, wherein particles having a weight-based median particle size d₅₀ of 1 μm are measured by the sedimentation method and particles having a weight-based median particle size d₅₀ of <1 μm are measured by the dynamic light scattering method, and/or
c) a BET specific surface area of from 1 to 250 m²/g, preferably from 5 to 200 m²/g, more preferably from 15 to 150 m²/g, even more preferably from 20 to 100 m²/g, measured using nitrogen and the BET method according to ISO 9277:2010.

According to another embodiment, the particulate mineral-based material comprises alkaline earth metal carbonates, alkaline earth metal phosphates, alkaline earth metal sulphates, alkaline earth metal oxides, alkaline earth metal hydroxides and mixtures thereof.

According to yet another embodiment, i) the particulate mineral-based material comprises at least one calcium ion-comprising material, preferably selected from the group comprising natural ground calcium carbonate (NGCC) such as marble, limestone and chalk, precipitated calcium carbonate (PCC), hydroxyapatite and mixtures thereof, ii) the particulate mineral-based material comprises at least one magnesium ion-comprising material, preferably selected from the group comprising anhydrous magnesium carbonate i.e. upsalite or magnesite (MgCO₃), magnesium oxide (MgO), artinite (Mg₂(CO₃)(OH)₂·3H₂O), 15 dypingite (Mg₅(CO₃)₄(OH)₂·5H₂O), giorgiosite (Mg₅(CO₃)₄(OH)₂·5H₂O), pokrovskite (Mg₂(CO₃)(OH)₂·H₂O), barringtonite (MgCO₃·2H₂O), lansfordite (MgCO₃·5H₂O), nesquehonite (MgCO₃·3H₂O), talc (Mg₃Si₄O₁₀(OH)₂) and mixtures thereof or iii) the particulate mineral-based material comprises at least one calcium ion-comprising material and at least one magnesium ion-comprising material, preferably selected from the group comprising dolomite, huntite, and mixtures thereof.

According to one embodiment, the humectant is an organic-based humectant or an inorganic salt comprising zinc cations, potassium cations, magnesium cations, calcium cations, chloride anions and mixtures thereof, preferably the humectant is selected from the group comprising calcium chloride, potassium nitrate, magnesium sulfate, zinc sulfate, glycerol and mixtures thereof, preferably calcium chloride and/or glycerol.

According to another embodiment, the surfactant is selected from the group consisting of cationic surfactants, anionic surfactants, nonionic surfactants and mixtures thereof, more preferably the surfactant is one or more anionic surfactant(s) selected from a salt of fatty acid, a benzoate, an alkylsulfosuccinate, a dialkylsulfosuccinate, a polycarboxylate, a salt of alkylsulfuric acid ester, an alkyl sulfate, an alkyl diglycol ether sulfate, a salt of alcohol sulfuric acid ester, a sulfonate such as an alkyl sulfonate, an aryl sulfonate and/or alkylaryl sulfonate, e.g. a lignin sulfonate, an alkyldiphenyl ether disulfonate, a polystyrene sulfonate, a phenol sulfonate condensed with formaldehyde, a salt of alkylphosphoric acid ester, an alkylaryl phosphate, a styrylaryl phosphate; a salt of polyoxyethylene alkyl ether sulfuric acid ester, a polyoxyethylene alkylaryl ether sulfate, a polyoxyethylene styrylaryl ether sulfate, an ammonium polyoxyethylene styrylaryl ether sulfate, a salt of polyoxyethylene alkylaryl ether sulfuric acid ester, a polyoxyethylene alkyl ether phosphate, a salt of polyoxyethylene alkylaryl phosphoric acid ester, a polyoxyethylene styrylaryl ether phosphoric acid ester or its salt and a salt of maleic anhydride alkylene copolymer; one or more nonionic surfactant(s) selected from an organomodified trisiloxane, organosilicone, polyethylene glycol monoether, sorbitan fatty acid ester, a glycerin fatty acid ester, a fatty acid polyglyceride, a fatty acid alcohol polyglycol ether, an acetylene glycol, an acetylene alcohol, an oxyalkylene block polymer, a polyoxyethylene alkyl ether, a polyoxyethylene alkylaryl ether, a polyoxyethylene styrylaryl ether, a polyoxyethylene glycol alkyl ether, a polyoxyethylene fatty acid ester, a polyoxyethylene sorbitan fatty acid ester, a polyoxyethylene sorbitol fatty acid ester, a polyoxyethylene glycerin fatty acid ester, a polyoxyethylene hydrogenated castor oil, a polyoxyethylene castor oil and a polyoxypropylene fatty acid ester, one or more cationic surfactant(s) selected from an alkoxylated fatty amine and amphoteric surfactants; and mixtures thereof.

According to yet another embodiment, the composition further comprises a dispersing agent, preferably the dispersing agent is made of monomers and/or co-monomers selected from the group consisting of acrylic acid, methacrylic acid, itaconic acid, crotonic acid, fumaric acid, maleic anhydride acid, isocrotonic acid, aconitic acid (cis or trans), mesaconic acid, sinapinic acid, undecylenic acid, angelic acid, canellic acid, hydroxyacrylic acid, acrolein, acrylamide, acrylonitrile, dimethylaminoethyl methacrylate, vinylpyrrolidone, vinylcaprolactam, ethylene, propylene, isobutylene, diisobutylene, vinyl acetate, styrene, alpha-methyl styrene, methyl vinyl ketone, the esters of acrylic and methacrylic acids and mixtures thereof, more preferably the dispersing agent is poly(acrylic acid) and/or poly (methacrylic acid).

According to one embodiment, the dispersing agent is present in an amount ranging from 0.01 to 3 wt.-%, based on the total weight of the composition.

According to one embodiment, the composition further comprises a plant nutrient element selected from the group consisting of zinc, copper, iron, manganese, boron, molybdenum, nitrogen, silicium, sodium, chlorine, phosphorus, potassium, calcium, magnesium, sulphur and mixtures thereof, a pesticide, or sun protection compound.

According to a further aspect, a method of formulating a liquid foliar composition, as defined herein, is provided, the method comprising the steps of
a) providing a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
b) providing a humectant and/or a surfactant, and
c) dissolving and/or dispersing the particulate mineral-based material and the humectant and/or the surfactant in an aqueous solvent or dispersion medium such that the particulate mineral-based material is present in an amount ranging from 0.1 to 60 wt.-%, based on the total weight of the composition, and the humectant is present in an amount ranging from 0.01 to 10 wt.-%, based on the total weight of the composition and/or the surfactant is present in an amount ranging from 0.01 to 3 wt.-%, based on the total weight of the composition.

According to one embodiment, step c) further comprises dissolving and/or dispersing a dispersing agent in the aqueous solvent or dispersion medium such that the dispersing agent is present in an amount ranging from 0.01 to 3 wt.-%, based on the total weight of the composition.

According to another aspect, a method of increasing the wettability of a surface, preferably plant surface or fungi surface, is provided, the method comprising the steps of
a) providing a liquid foliar composition as defined herein, and
b) applying the liquid foliar composition to the surface, preferably plant surface or fungi surface.

According to a further aspect, the use of liquid foliar composition as defined herein in agricultural and horticultural applications is provided.

According to another aspect, the use of a particulate mineral-based material comprising at least one alkaline earth metal ion-comprising material, iron oxide or zinc oxide in a liquid foliar composition is provided, wherein the particulate mineral-based material has a weight-based median particle size d₅₀ value in the range from 5 nm to 20 μm.

According to one embodiment, the particulate mineral-based material combined with a humectant and/or a surfactant provides an increased wettability in combination with a long-lasting effect for a surface, preferably plant surface or fungi surface, on which the liquid foliar composition is applied.

It should be understood that for the purpose of the present invention the following terms have the following meaning.

Where the term “comprising” is used in the present description and claims, it does not exclude other elements. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Where an indefinite or definite article is used when referring to a singular noun, e.g. “a”, “an” or “the”, this includes a plural of that noun unless something else is specifically stated.

Terms like “obtainable” or “definable” and “obtained” or “defined” are used interchangeably. This e.g. means that, unless the context clearly dictates otherwise, the term “obtained” does not mean to indicate that e.g. an embodiment must be obtained by e.g. the sequence of steps following the term “obtained” though such a limited understanding is always included by the terms “obtained” or “defined” as a preferred embodiment.

According to the present invention, the liquid foliar composition comprises
a) an aqueous solvent or dispersion medium,
b) from 0.1 to 60 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.01 to 10 wt.-%, based on the total weight of the composition, of a humectant, and/or
d) from 0.01 to 3 wt.-%, based on the total weight of the composition, of a surfactant.

It has been especially found out that the above liquid foliar composition according to the present invention must comprise a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm and a humectant and/or surfactant dissolved or dispersed in an aqueous solvent or dispersion medium in order to improve the wettability on the applied surface, preferably plant or fungi surface, which leads to better fertilizing properties such as increased nutrients uptake and long lasting effect once the liquid composition is applied on plant leaves.

In the following, it is referred to further details of the present invention and especially the foregoing liquid foliar composition.

One requirement of the present invention is that the foliar composition is liquid and thus comprises a solvent as liquid phase. Preferably, the liquid phase comprises, preferably consists of, water such as tap water. However, said term does not exclude that the liquid phase of the foliar composition comprises minor amounts of at least one water-miscible organic solvent selected from the group comprising methanol, ethanol, acetone, acetonitrile, tetrahydrofuran, 1-methoxy-2-propanol, dimethyl sulfoxide (DMSO), methyl-2-pyrrolidone (NMP), dodecanol and mixtures thereof. If the foliar composition comprises at least one water-miscible organic solvent, the liquid phase of the foliar composition comprises the at least one water-miscible organic solvent in an amount of from 0.1 to 40.0 wt.-% preferably from 0.1 to 30.0 wt.-%, more preferably from 0.1 to 20.0 wt.-% and most preferably from 0.1 to 10.0 wt.-%, based on the total weight of the liquid phase of the foliar composition. For example, the liquid phase of the foliar composition consists of water, such as tab water. In view of this, the liquid foliar composition comprises an aqueous solvent or aqueous dispersion medium. It is to be noted that the liquid foliar composition usually comprises remaining solids and thus the liquid foliar composition preferably comprises an aqueous dispersion medium.

It is further required that the liquid foliar composition comprises a particulate mineral-based material comprising at least one alkaline earth metal ion-comprising material, iron oxide or zinc oxide. Advantageous effects with respect to the wettability on the applied surfaces can be especially achieved when using at least one alkaline earth metal ion-comprising material as the particulate mineral-based material. Thus, the liquid foliar composition preferably comprises at least one alkaline earth metal ion-comprising material as the particulate mineral-based material.

It is appreciated that the particulate mineral-based material preferably comprises alkaline earth metal carbonates, alkaline earth metal phosphates, alkaline earth metal sulphates, alkaline earth metal oxides, alkaline earth metal hydroxides and mixtures thereof. In a preferred embodiment, the particulate mineral-based material comprises alkaline earth metal carbonates, alkaline earth metal phosphates, alkaline earth metal oxides, alkaline earth metal hydroxides and mixtures thereof. More preferably, the particulate mineral-based material comprises alkaline earth metal carbonates, alkaline earth metal oxides, alkaline earth metal hydroxides and mixtures thereof. Most preferably, the particulate mineral-based material comprises alkaline earth metal carbonates, alkaline earth metal hydroxides and mixtures thereof. For example, the particulate mineral-based material comprises alkaline earth metal carbonates.

In one embodiment, the particulate mineral-based material comprises alkaline earth metal carbonates in combination with a particulate mineral-based material selected from the group comprising, preferably consisting of, alkaline earth metal phosphates, alkaline earth metal oxides, alkaline earth metal hydroxides and mixtures thereof. For example, the particulate mineral-based material comprises alkaline earth metal carbonates in combination with a particulate mineral-based material selected from the group comprising, preferably consisting of, alkaline earth metal oxides, alkaline earth metal hydroxides and mixtures thereof.

In view of the above, the particulate mineral-based material preferably comprises calcium ions and/or magnesium ions as the alkaline earth metal ions.

For example, the particulate mineral-based material preferably comprises calcium ions as the alkaline earth metal ions. Thus, the particulate mineral-based material comprises at least one calcium ion-comprising material and/or at least one magnesium ion-comprising material.

In case the particulate mineral-based material comprises at least one calcium ion-comprising material, the at least one calcium ion-comprising material is preferably selected from the group comprising natural ground calcium carbonate (NGCC) such as marble, limestone and chalk, precipitated calcium carbonate (PCC), hydroxyapatite and mixtures thereof.

Alternatively, if the particulate mineral-based material comprises at least one magnesium ion-comprising material, the magnesium ion-comprising material is preferably selected from the group comprising anhydrous magnesium carbonate i.e. upsalite or magnesite (MgCO₃), magnesium oxide (MgO), artinite (Mg₂(CO₃)(OH)₂·3H₂O), 15 dypingite (Mg₅(CO₃)₄(OH)₂·5H₂O), giorgiosite (Mg₅(CO₃)₄(OH)₂·5H₂O), pokrovskite (Mg₂(CO₃)(OH)₂·0.5H₂O), barringtonite (MgCO₃·2H₂O), lansfordite (MgCO₃·5H₂O), nesquehonite (MgCO₃·3H₂O), talc (Mg₃Si₄O₁₀(OH)₂) and mixtures thereof.

Alternatively, if the particulate mineral-based material comprises at least one calcium ion-comprising material and at least one magnesium ion-comprising material, the material is preferably selected from the group comprising dolomite, huntite, and mixtures thereof.

In one embodiment, the particulate mineral-based material is an iron oxide selected from a Fe(II) oxide, a Fe(III) oxide, a Fe(II,III) oxide or mixtures thereof. It is to be noted that the wording “iron oxide” also includes iron oxyhydroxides. For example, the iron oxide is selected from the group comprising, preferably consisting of, agakenite (β-FeO(OH)), hematite (Fe₂O₃), feroxyhyte (δ-FeO(OH)), ferrihydrite (Fe₁₀O₁₄(OH)₂), goethite (α-FeO(OH)), lepidocrocite (γ-FeO(OH)), maghemite (γ-Fe₂O₃), magnetite (Fe₃O₄), wiastite (FeO) and mixtures thereof.

Preferably, the iron oxide is an iron(III) oxide or a Fe(II,III) oxide. For example, the iron(III) oxide or the a Fe(II,III) oxide is selected from the group comprising, preferably consisting of, hematite (Fe₂O₃), feroxyhyte (FeO(OH)), ferrihydrite (Fe₁₀O₁₄(OH)₂), goethite (α-FeO(OH)), lepidocrocite (γ-FeO(OH)), maghemite (γ-Fe₂O₃), magnetite (Fe₃O₄), and mixtures thereof. More preferably, the iron(III) oxide or the Fe(II,III) oxide is selected from the group comprising, preferably consisting of, hematite (Fe₂O₃), feroxyhyte (FeO(OH)), ferrihydrite (Fe₁₀O₁₄(OH)₂), goethite (α-FeO(OH)), lepidocrocite (γ-FeO(OH)), maghemite (γ-Fe₂O₃), magnetite (Fe₃O₄) and mixtures thereof. Most preferably, the iron(III) oxide or the Fe(II,III) oxide is selected from the group comprising, preferably consisting of, hematite (Fe₂O₃), magnetite (Fe₃O₄) and mixtures thereof. In particular, the iron(III) oxide is selected from the group comprising, preferably consisting of, hematite (Fe₂O₃), feroxyhyte (FeO(OH)), ferrihydrite (Fe₁₀O₁₄(OH)₂), goethite (α-FeO(OH)), lepidocrocite (γ-FeO(OH)), maghemite (γ-Fe₂O₃), and mixtures thereof or the Fe(II,III) oxide is magnetite (Fe₃O₄). More preferably, the iron(III) oxide is selected from the group comprising, preferably consisting of, hematite (Fe₂O₃), feroxyhyte (FeO(OH)), ferrihydrite (Fe₁₀O₁₄(OH)₂), goethite (α-FeO(OH)), lepidocrocite (γ-FeO(OH)), maghemite (γ-Fe₂O₃), and mixtures thereof or the Fe(II,III) oxide is magnetite (Fe₃O₄). Most preferably, the iron(III) oxide is hematite (Fe₂O₃) or the Fe(II,III) oxide is magnetite (Fe₃O₄).

It is appreciated that Fe₂O₃, e.g. hematite, can be used interchangeable with Fe₃O₄. In one embodiment, the iron oxide is thus selected from the group comprising, preferably consisting of, hematite (Fe₂O₃), magnetite (Fe₃O₄) and mixtures thereof.

It is preferred that the particulate mineral-based material comprises at least one calcium ion-comprising material, preferably selected from the group comprising natural ground calcium carbonate (NGCC) such as marble, limestone and chalk, precipitated calcium carbonate (PCC), hydroxyapatite and mixtures thereof. More preferably, the particulate mineral-based material comprises at least one calcium ion-comprising material selected from the group comprising natural ground calcium carbonate (NGCC) such as marble, limestone and chalk, and precipitated calcium carbonate (PCC). Most preferably, the particulate mineral-based material comprises at least one calcium ion-comprising material being natural ground calcium carbonate (NGCC) such as marble, limestone or chalk.

The inventors further found out that the particulate mineral-based material must have a specific median particle size d₅₀ value in order to provide an improvement in the wettability on surfaces on which the liquid composition is applied.

More precisely, it is advantageous if the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method.

Preferably, the particulate mineral-based material has a weight-based median particle size d₅₀ value in the range from 10 nm to 10 μm, more preferably from 20 nm to 1 μm, still more preferably from 30 nm to 800 nm, even more preferably from 40 nm to 500 nm and most preferably from 50 nm to 200 nm.

Additionally or alternatively, the particulate mineral-based material has a weight-based top cut d₉₈ value in the range from 50 nm to 100 μm, preferably from 100 nm to 10 μm, more preferably from 120 nm to 5 μm, even more preferably from 130 nm to 1 μm and most preferably from 130 nm to 800 nm.

In one embodiment, the particulate mineral-based material thus has a weight-based median particle size d₅₀ value in the range from 5 nm to 20 μm and a weight-based top cut d₉₈ value in the range from 50 nm to 100 μm, preferably from 100 nm to 10 μm, more preferably from 120 nm to 5 μm, even more preferably from 130 nm to 1 μm and most preferably from 130 nm to 800 nm.

In a further embodiment, the particulate mineral-based material has a weight-based median particle size d₅₀ value in the range from 10 nm to 10 μm, more preferably from 20 nm to 1 μm, still more preferably from 30 nm to 800 nm, even more preferably from 40 nm to 500 nm and most preferably from 50 nm to 200 nm and a weight-based top cut d₉₈ value in the range from 50 nm to 100 μm, preferably from 100 nm to 10 μm, more preferably from 120 nm to 5 μm, even more preferably from 130 nm to 1 μm and most preferably from 130 nm to 800 nm.

For example, the particulate mineral-based material has a weight-based median particle size d₅₀ value in the range from 50 nm to 200 nm and a weight-based top cut d₉₈ value in the range from 150 nm to 800 nm.

The “particle size” of particulate materials is described herein by its weight-based distribution of particle sizes dx. For particles having a weight-based median particle size d₅₀ of 1 μm, the weight-based median particle size d₅₀ and top cut d₉₈ values were measured by the sedimentation method, which is an analysis of sedimentation behaviour in a gravimetric field. The d₅₀ or d₉₈ value, measured using the sedimentation method, indicates a diameter value such that 50% or 98% by weight, respectively, of the particles have a diameter of less than this value. The measurement is made with a Sedigraph™ 5120 of Micromeritics Instrument Corporation, USA. The method and the instrument are known to the skilled person and are commonly used to determine particle size distributions. The measurement is carried out in an aqueous solution of 0.1 wt. % Na₄P₂O₇. The samples are dispersed using a high speed stirrer and sonication.

For particles having a weight-based median particle size d₅₀ of <1 μm, the weight-based median particle size d₅₀ and top cut d₉₈ values were evaluated using a Malvern Zetasizer ZS90 Dynamic Light Scattering System. The d₅₀ or d₉₈ value, measured using a Malvern Zetasizer ZS90 Dynamic Light Scattering System, indicates a diameter value such that 50% or 98% by weight, respectively, of the particles have a diameter of less than this value. The raw data obtained by the measurement are analyzed using the Mie theory, with a particle refractive index of 1.57 and an absorption index of 0.01.

Thus, particles having a weight-based median particle size d₅₀ of 1 μm are measured by the sedimentation method and, if present, particles having a weight-based median particle size d₅₀ of <1 μm are measured by the dynamic light scattering method throughout the present invention if not stated otherwise.

Additionally or alternatively, the particulate mineral-based material has a BET specific surface area of from 1 to 250 m²/g, preferably from 15 to 150 m²/g, more preferably from 20 to 100 m²/g, measured using nitrogen and the BET method according to ISO 9277:2010. In one embodiment, the particulate mineral-based material has a BET specific surface area of from 5 to 200 m²/g, preferably from 15 to 150 m²/g, more preferably from 20 to 100 m²/g, measured using nitrogen and the BET method according to ISO 9277:2010.

In one embodiment, the particulate mineral-based material thus has a weight-based median particle size d₅₀ value in the range from 5 nm to 20 μm and a weight-based top cut d₉₈ value in the range from 50 nm to 100 μm, preferably from 100 nm to 10 μm, more preferably from 120 nm to 5 μm, even more preferably from 130 nm to 1 μm and most preferably from 130 nm to 800 nm and a BET specific surface area of from 1 to 250 m²/g, preferably from 5 to 200 m²/g, more preferably from 15 to 150 m²/g, even more preferably from 20 to 100 m²/g, measured using nitrogen and the BET method according to ISO 9277:2010.

In a further embodiment, the particulate mineral-based material has a weight-based median particle size d₅₀ value in the range from 10 nm to 10 μm, more preferably from 20 nm to 1 μm, still more preferably from 30 nm to 800 nm, even more preferably from 40 nm to 500 nm and most preferably from 50 nm to 200 nm and a weight-based top cut d₉₈ value in the range from 50 nm to 100 μm, preferably from 100 nm to 10 μm, more preferably from 120 nm to 5 μm, even more preferably from 130 nm to 1 μm and most preferably from 130 nm to 800 nm and a BET specific surface area of from 1 to 250 m²/g, preferably from 5 to 200 m²/g, more preferably from 15 to 150 m²/g, even more preferably from 20 to 100 m²/g, measured using nitrogen and the BET method according to ISO 9277:2010.

For example, the particulate mineral-based material has a weight-based median particle size d₅₀ value in the range from 50 nm to 200 nm and a weight-based top cut d₉₈ value in the range from 130 nm to 800 nm and a BET specific surface area of from 20 to 100 m²/g, measured using nitrogen and the BET method according to ISO 9277:2010.

It is further appreciated that the liquid foliar composition comprises the particulate mineral-based material in an amount ranging from 0.1 to 60 wt.-%, based on the total weight of the composition. Preferably, the liquid foliar composition comprises the particulate mineral-based material in an amount ranging from 0.1 to 50 wt.-%, preferably from 0.1 to 40 wt.-%, more preferably from 0.1 to 30 wt.-%, even more preferably from 0.1 to 20 wt.-% and most preferably from 0.1 to 10 wt.-%, based on the total weight of the composition. In one embodiment, the liquid foliar composition comprises the particulate mineral-based material in an amount ranging from 1 to 50 wt.-%, preferably from 1 to 40 wt.-%, more preferably from 1 to 30 wt.-%, even more preferably from 1 to 20 wt.-% and most preferably from 1 to 10 wt.-%, based on the total weight of the composition.

The liquid foliar composition further comprises a humectant. A “humectant” in the meaning of the present invention refers to a moisturizing agent. The humectant increases the drying time of the liquid foliar composition and thus enable more ions/nutrients to be absorbed. It is appreciated that the humectant can be any compound having a moisturizing effect known in the art and that does not provide harm to the surface, i.e. plant surfaces and fungi surfaces, onto which it is applied.

In one embodiment, the humectant is an organic-based humectant or an inorganic salt. Preferably, the humectant is an inorganic salt comprising zinc cations, potassium cations, magnesium cations, calcium cations, chloride anions and mixtures thereof. For example, the humectant is selected from the group comprising calcium chloride, potassium nitrate, magnesium sulfate, zinc sulfate, glycerol and mixtures thereof. Most preferably, the humectant is selected from the group comprising calcium chloride, potassium nitrate, magnesium sulfate, glycerol and mixtures thereof. For example, the humectant is calcium chloride and/or glycerol.

In one embodiment, the humectant is calcium chloride or glycerol, preferably calcium chloride. In another embodiment, the humectant is a mixture of calcium chloride and glycerol.

It is appreciated that the humectant differs in composition from the particulate mineral-based material comprising at least one alkaline earth metal ion-comprising material, iron oxide or zinc oxide. Thus, if the particulate mineral-based material comprises e.g. at least one alkaline earth metal ion-comprising material being ground calcium carbonate (NGCC) or precipitated calcium carbonate (PCC), the humectant cannot be a calcium carbonate. However, it is appreciated that the cation of the humectant and of the particulate mineral-based material comprising at least one alkaline earth metal ion-comprising material, iron oxide or zinc oxide may be the same. Thus, if the particulate mineral-based material comprises e.g. at least one alkaline earth metal ion-comprising material being ground calcium carbonate (NGCC) or precipitated calcium carbonate (PCC), the humectant may comprise calcium cations such as calcium chloride.

Thus, in a preferred embodiment, the liquid foliar composition comprises
a) an aqueous solvent or dispersion medium,
b) from 0.1 to 60 wt.-%, based on the total weight of the composition, of a particulate mineral-based material comprising at least one alkaline earth metal ion-comprising material, preferably ground calcium carbonate (NGCC) or precipitated calcium carbonate (PCC), wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.01 to 10 wt.-%, based on the total weight of the composition, of a humectant comprising calcium cations, preferably calcium chloride and/or glycerol.

In another embodiment, the liquid foliar composition comprises a mixture of humectants, preferably a mixture of humectants, whereby one humectant is calcium chloride and one or more other humectant(s) is/are selected from the group comprising potassium nitrate, magnesium sulfate, zinc sulfate and glycerol. For example, the liquid foliar composition comprises a mixture of humectants comprising calcium chloride, potassium nitrate, magnesium sulfate, and zinc sulfate. If a mixture of humectants is present in the liquid foliar composition, the single humectants can be present in equal or differing amounts. Preferably, the single humectants are present in differing amounts in the liquid foliar composition.

Thus, in a preferred embodiment, the liquid foliar composition comprises
a) an aqueous solvent or dispersion medium,
b) from 0.1 to 60 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.01 to 10 wt.-%, based on the total weight of the composition, of a mixture of humectants, wherein one humectant is calcium chloride and one or more other humectant(s) is/are selected from the group comprising potassium nitrate, magnesium sulfate, zinc sulfate and glycerol.

For example, the liquid foliar composition comprises
a) an aqueous solvent or dispersion medium,
b) from 0.1 to 60 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.01 to 10 wt.-%, based on the total weight of the composition, of a mixture of humectants, wherein one humectant is calcium chloride and one or more other humectant(s) is/are selected from the group comprising potassium nitrate, magnesium sulfate, zinc sulfate and glycerol.

In another embodiment, the liquid foliar composition comprises a mixture of humectants, whereby one humectant is potassium nitrate and one or more other humectant(s) is/are selected from the group comprising calcium chloride, magnesium sulfate, zinc sulfate and glycerol.

For example, the liquid foliar composition comprises
a) an aqueous solvent or dispersion medium,
b) from 0.1 to 60 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.01 to 10 wt.-%, based on the total weight of the composition, of a mixture of humectants, wherein one humectant is potassium nitrate and one or more other humectant(s) is/are selected from the group comprising calcium chloride, magnesium sulfate, zinc sulfate and glycerol.

For example, the liquid foliar composition comprises
a) an aqueous solvent or dispersion medium,
b) from 0.1 to 60 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.01 to 10 wt.-%, based on the total weight of the composition, of a mixture of humectants, wherein one humectant is potassium nitrate and one or more other humectant(s) is/are selected from the group comprising calcium chloride, magnesium sulfate, zinc sulfate and glycerol.

In another embodiment, the liquid foliar composition comprises a mixture of humectants, whereby one humectant is magnesium sulfate and one or more other humectant(s) is/are selected from the group comprising calcium chloride, potassium nitrate, zinc sulfate and glycerol.

For example, the liquid foliar composition comprises
a) an aqueous solvent or dispersion medium,
b) from 0.1 to 60 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.01 to 10 wt.-%, based on the total weight of the composition, of a mixture of humectants, wherein one humectant is magnesium sulfate and one or more other humectant(s) is/are selected from the group comprising calcium chloride, potassium nitrate, zinc sulfate and glycerol.

For example, the liquid foliar composition comprises
a) an aqueous solvent or dispersion medium,
b) from 0.1 to 60 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.01 to 10 wt.-%, based on the total weight of the composition, of a mixture of humectants, wherein one humectant is magnesium sulfate and one or more other humectant(s) is/are selected from the group comprising calcium chloride, potassium nitrate, zinc sulfate and glycerol.

In one embodiment, the liquid foliar composition comprises
a) an aqueous solvent or dispersion medium,
b) from 0.1 to 60 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.01 to 10 wt.-%, based on the total weight of the composition, of a mixture of humectants comprising, preferably consisting of, calcium chloride, potassium nitrate, magnesium sulfate and zinc sulfate.

If the humectant comprises, preferably consists of, calcium chloride, potassium nitrate, magnesium sulfate and zinc sulfate, it is appreciated that calcium chloride, potassium nitrate and magnesium sulfate are preferably present in equal amounts, whereas the amount of the zinc sulfate may differ from the other humectants. For example, calcium chloride, potassium nitrate and magnesium sulfate are preferably present in equal amounts, whereas the amount of zinc sulfate is below the amount of the other humectants.

In another embodiment, the humectant comprises, preferably consists of, calcium chloride, potassium nitrate, magnesium sulfate and zinc sulfate, wherein calcium chloride, potassium nitrate and magnesium sulfate are present in differing amounts, whereas the amount of the zinc sulfate is below the amounts of the other humectants.

In one embodiment, the humectant comprises, preferably consists of, calcium chloride, potassium nitrate, magnesium sulfate and zinc sulfate, wherein calcium chloride, potassium nitrate and magnesium sulfate are present in differing amounts, whereas the amount of zinc sulfate is below the amount of the calcium chloride.

It is further required that the liquid foliar composition comprises the humectant in an amount ranging from 0.01 to 10 wt.-%, based on the total weight of the composition. Preferably, the liquid foliar composition comprises the humectant in an amount ranging from 0.01 to 8 wt.-%, preferably from 0.02 to 6 wt.-%, more preferably from 0.03 to 5 wt.-%, even more preferably from 0.0.4 to 4 wt.-% and most preferably from 0.05 to 3 wt.-%, based on the total weight of the composition.

It is to be noted that the amount of the humectant refers to the total amount of humectant. That is to say, if a mixture of humectants is present, the amount of the humectant refers to the total amount of the humectant mixture in the liquid foliar composition.

In view of this, the liquid foliar composition preferably comprises
a) an aqueous solvent or dispersion medium,
b) from 0.1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.01 to 10 wt.-%, preferable from 0.01 to 8 wt.-%, more preferably from 0.02 to 6 wt.-%, still more preferably from 0.03 to 5 wt.-%, even more preferably from 0.04 to 4 wt.-% and most preferably from 0.05 to 3 wt.-%, based on the total weight of the composition, of a humectant.

For example, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.01 to 10 wt.-%, preferable from 0.01 to 8 wt.-%, more preferably from 0.02 to 6 wt.-%, still more preferably from 0.03 to 5 wt.-%, even more preferably from 0.04 to 4 wt.-% and most preferably from 0.05 to 3 wt.-%, based on the total weight of the composition, of a humectant.

In one embodiment, the liquid foliar composition preferably comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.05 to 3 wt.-%, based on the total weight of the composition, of a humectant.

For example, the liquid foliar composition comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.05 to 3 wt.-%, based on the total weight of the composition, of a humectant.

In general, the particulate mineral-based material has a weight-based median particle size d₅₀ value in the range from 5 nm to 20 μm. However, it may be preferred that the particulate mineral-based material has a weight-based median particle size d₅₀ value in the range from 1 μm to 20 μm. In this embodiment, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 1 μm to 20 μm, wherein particles having a weight-based median particle size d₅₀ of 1 μm are measured by the sedimentation method, and
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant.

For example, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 1 μm to 20 μm, wherein particles having a weight-based median particle size d₅₀ of 1 μm are measured by the sedimentation method, and
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant.

In one embodiment, the liquid foliar composition comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 1 μm to 20 μm, wherein particles having a weight-based median particle size d₅₀ of 1 μm are measured by the sedimentation method, and
c) from 0.05 to 3 wt.-%, based on the total weight of the composition, of a humectant.

In another embodiment, the particulate mineral-based material has a weight-based median particle size d₅₀ value in the range from 5 nm to <1 μm. This is specifically advantageous for increasing the wettability of a surface. In this embodiment, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, iron or zinc oxide, wherein the particulate mineral-based material has a weight-based median particle size d₅₀ value in the range from 5 nm to <1 μm, wherein particles having a weight-based median particle size d₅₀ of <1 μm are measured by the dynamic light scattering method, and
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant.

For example, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to <1 μm, wherein particles having a weight-based median particle size d₅₀ of <1 μm are measured by the dynamic light scattering method, and
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant.

In one embodiment, the liquid foliar composition comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to <1 μm, wherein particles having a weight-based median particle size d₅₀ of <1 μm are measured by the dynamic light scattering method, and
c) from 0.05 to 3 wt.-%, based on the total weight of the composition, of a humectant.

Additionally or alternatively, the liquid foliar composition comprises a surfactant. The surfactant is advantageous for lowering the surface tension and thus further improves the wettability on the surface onto which the composition is applied. It is thus appreciated that the surfactant can be any surfactant known in the art and that does not provide harm to the surface, i.e. plant surfaces and fungi surfaces, onto which it is applied.

Thus, the surfactant is preferably selected from the group consisting of cationic surfactants, anionic surfactants, nonionic surfactants and mixtures thereof.

According to a preferred embodiment of the present invention, the surfactant is one or more anionic surfactant(s) selected from a salt of fatty acid, a benzoate, an alkylsulfosuccinate, a dialkylsulfosuccinate, a polycarboxylate, a salt of alkylsulfuric acid ester, an alkyl sulfate, an alkyl diglycol ether sulfate, a salt of alcohol sulfuric acid ester, a sulfonate such as an alkyl sulfonate, an aryl sulfonate and/or alkylaryl sulfonate, e.g. a lignin sulfonate, an alkyldiphenyl ether disulfonate, a polystyrene sulfonate, a phenol sulfonate condensed with formaldehyde, a salt of alkylphosphoric acid ester, an alkylaryl phosphate, a styrylaryl phosphate; a salt of polyoxyethylene alkyl ether sulfuric acid ester, a polyoxyethylene alkylaryl ether sulfate, a polyoxyethylene styrylaryl ether sulfate, an ammonium polyoxyethylene styrylaryl ether sulfate, a salt of polyoxyethylene alkylaryl ether sulfuric acid ester, a polyoxyethylene alkyl ether phosphate, a salt of polyoxyethylene alkylaryl phosphoric acid ester, a polyoxyethylene styrylaryl ether phosphoric acid ester or its salt and a salt of maleic anhydride alkylene copolymer; one or more nonionic surfactant(s) selected from an organomodified trisiloxane, organosilicone, polyethylene glycol monoether, e.g. isotridecyl polyethylene glycol ether, sorbitan fatty acid ester, a glycerin fatty acid ester, a fatty acid polyglyceride, a fatty acid alcohol polyglycol ether, an acetylene glycol, an acetylene alcohol, an oxyalkylene block polymer, a polyoxyethylene alkyl ether, a polyoxyethylene alkylaryl ether, a polyoxyethylene styrylaryl ether, a polyoxyethylene glycol alkyl ether, a polyoxyethylene fatty acid ester, a polyoxyethylene sorbitan fatty acid ester, a polyoxyethylene sorbitol fatty acid ester, a polyoxyethylene glycerin fatty acid ester, a polyoxyethylene hydrogenated castor oil, a polyoxyethylene castor oil and a polyoxypropylene fatty acid ester, one or more cationic surfactant(s) selected from an alkoxylated fatty amine and amphoteric surfactants; and mixtures thereof.

In one embodiment, the surfactant is a sulfonate. Preferably, the sulfonate is selected from the group consisting of an aryl sulfonate, an alkylaryl sulfonate and their formaldehyde condensates. The alkyl moiety in the sulfonate to be used in the present invention may be linear or branched. It may, for example, be a C1-12 alkyl moiety such as methyl, ethyl, propyl, butyl, pentyl, hexyl, heptyl, octyl, nonyl, decyl, undecyl or dodecyl. The aryl moiety in the sulfonate may be a monocyclic or polycyclic aryl such as a benzene ring or a naphthalene ring. As the salt of the sulfonate, various salts may be mentioned. It may, for example, be a salt with an alkali metal such as sodium or potassium, or a salt with an alkaline earth metal such as magnesium or calcium. More preferably, the sulfonate is an alkylaryl sulfonate or its formaldehyde condensate, even more preferably an alkylbenzene sulfonate, an alkylnaphthalene sulfonate, an alkylbenzene sulfonate condensed with formaldehyde or an alkylnaphthalene sulfonate condensed with formaldehyde. Most preferably, the sulfonate is an alkylbenzene sulfonate condensed with formaldehyde or an alkylnaphthalene sulfonate condensed with formaldehyde.

In a preferred embodiment, the surfactant is a non-ionic surfactant. More preferably, the surfactant is an organomodified trisiloxane. One example of an organomodified trisiloxane is polyether trisiloxane Such surfactants are well known in the art and are for example available under the tradename Break-Thru® from AlzChem Trostberg GmbH.

In a preferred embodiment, the surfactant is an organomodified trisiloxane, most preferably organomodified trisiloxane.

If present, it is preferred that the liquid foliar composition comprises the surfactant in an amount ranging from 0.01 to 3 wt.-%, based on the total weight of the composition. Preferably, the liquid foliar composition comprises the surfactant in an amount ranging from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition.

In one embodiment, the liquid foliar composition thus comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant.

For example, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant.

In one embodiment, the liquid foliar composition preferably comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.05 to 1.5 wt.-%, based on the total weight of the composition, of a surfactant.

For example, the liquid foliar composition comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.05 to 1.5 wt.-%, based on the total weight of the composition, of a surfactant.

In one embodiment, the surfactant is present in the liquid foliar composition if the particulate mineral-based material has a weight median particle size d₅₀ value in the range from 1 μm to 20 μm. wherein particles having a weight-based median particle size d₅₀ of 1 μm are measured by the sedimentation method.

Thus, the liquid foliar composition preferably comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 1 μm to 20 μm, wherein particles having a weight-based median particle size d₅₀ of 1 μm are measured by the sedimentation method, and
c) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant.

For example, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 1 μm to 20 μm, wherein particles having a weight-based median particle size d₅₀ of 1 μm are measured by the sedimentation method, and
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant.

It is to be noted that the liquid foliar composition may be free of a humectant if the composition comprises a surfactant.

However, it is preferred that the liquid foliar composition comprises a humectant and surfactant. This is advantageous as the humectant provides better fertilizing properties such as increased nutrients uptake and long lasting effect once the liquid composition is applied on plant leaves, whereas the surfactant improves the wettability on the applied surface, preferably plant or fungi surface.

In view of this, it is preferred that the liquid foliar composition comprises a humectant and surfactant.

Thus, the liquid foliar composition preferably comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant, and
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant.

For example, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 10 wt.-%, preferable from 0.01 to 8 wt.-%, more preferably from 0.02 to 6 wt.-%, still more preferably from 0.03 to 5 wt.-%, even more preferably from 0.04 to 4 wt.-% and most preferably from 0.05 to 3 wt.-%, based on the total weight of the composition, of a humectant, and
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant.

In one embodiment, the liquid foliar composition preferably comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.05 to 3 wt.-%, based on the total weight of the composition, of a humectant, and
d) from 0.05 to 1.5 wt.-%, based on the total weight of the composition, of a surfactant.

For example, the liquid foliar composition comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.05 to 3 wt.-%, based on the total weight of the composition, of a humectant, and
d) from 0.05 to 1.5 wt.-%, based on the total weight of the composition, of a surfactant.

In one embodiment, the surfactant is present in the liquid foliar composition if the particulate mineral-based material has a weight median particle size d₅₀ value in the range from 1 μm to 20 μm. wherein particles having a weight-based median particle size d₅₀ of 1 μm are measured by the sedimentation method.

Thus, the liquid foliar composition preferably comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 1 μm to 20 μm, wherein particles having a weight-based median particle size d₅₀ of 1 μm are measured by the sedimentation method,
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant, and
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant.

For example, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 1 μm to 20 μm, wherein particles having a weight-based median particle size d₅₀ of 1 μm are measured by the sedimentation method,
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant, and
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant.

Alternatively, the liquid foliar composition is preferably free of a surfactant if the particulate mineral-based material has a weight median particle size d₅₀ value in the range from 5 nm to 1 μm.

Thus, the liquid foliar composition preferably comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to <1 μm, wherein particles having a weight-based median particle size d₅₀ of <1 μm are measured by the dynamic light scattering method, and
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant,
wherein the liquid foliar composition is free of a surfactant.

For example, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to <1 μm, wherein particles having a weight-based median particle size d₅₀ of <1 μm are measured by the dynamic light scattering method, and
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant,
wherein the liquid foliar composition is free of a surfactant.

In one embodiment, the liquid foliar composition further comprises a dispersing agent. The dispersing agent is advantageous for stabilizing the liquid foliar composition by dispersing the solids in the composition. It is thus appreciated that the dispersing agent can be any dispersing agent known in the art and that does not provide harm to the surface, i.e. plant surfaces and fungi surfaces, onto which it is applied.

Thus, the dispersing agent is preferably made of monomers and/or co-monomers selected from the group consisting of acrylic acid, methacrylic acid, itaconic acid, crotonic acid, fumaric acid, maleic anhydride acid, isocrotonic acid, aconitic acid (cis or trans), mesaconic acid, sinapinic acid, undecylenic acid, angelic acid, canellic acid, hydroxyacrylic acid, acrolein, acrylamide, acrylonitrile, dimethylaminoethyl methacrylate, vinylpyrrolidone, vinylcaprolactam, ethylene, propylene, isobutylene, diisobutylene, vinyl acetate, styrene, alpha-methyl styrene, methyl vinyl ketone, the esters of acrylic and methacrylic acids and mixtures thereof.

Preferably, the dispersing agent is poly(acrylic acid) and/or poly (methacrylic acid). More preferably, the dispersing agent is poly(acrylic acid) or poly (methacrylic acid), e.g. poly(acrylic acid).

If present, it is preferred that the liquid foliar composition comprises the dispersing agent in an amount ranging from 0.01 to 3 wt.-%, based on the total weight of the composition. Preferably, the liquid foliar composition comprises the dispersing agent in an amount ranging from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition.

In view of this, the liquid foliar composition preferably comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant, and/or
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant, and
e) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a dispersing agent.

For example, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method, and
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant, and/or
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant, and
e) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a dispersing agent.

In one embodiment, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant, and
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a dispersing agent.

For example, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant, and
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a dispersing agent.

In the foregoing embodiment, the liquid foliar composition is preferably free of surfactant(s).

Alternatively, the liquid foliar composition preferably comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant, and
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a dispersing agent.

For example, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant, and
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a dispersing agent.

In one embodiment, the liquid foliar composition comprises a humectant, a surfactant and a dispersing agent. In this embodiment, the liquid foliar composition preferably comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant,
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant, and
e) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a dispersing agent.

For example, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant,
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant, and
e) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a dispersing agent.

Preferably, the liquid foliar composition preferably comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.05 to 3 wt.-%, based on the total weight of the composition, of a humectant, and
d) from 0.05 to 1.5 wt.-%, based on the total weight of the composition, of a dispersing agent.

For example, the liquid foliar composition comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.05 to 3 wt.-%, based on the total weight of the composition, of a humectant, and
d) from 0.05 to 1.5 wt.-%, based on the total weight of the composition, of a dispersing agent.

Alternatively, the liquid foliar composition preferably comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.05 to 1.5 wt.-%, based on the total weight of the composition, of a surfactant, and
d) from 0.05 to 1.5 wt.-%, based on the total weight of the composition, of a dispersing agent.

For example, the liquid foliar composition comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.05 to 1.5 wt.-%, based on the total weight of the composition, of a surfactant, and
d) from 0.05 to 1.5 wt.-%, based on the total weight of the composition, of a dispersing agent.

In one embodiment, the liquid foliar composition preferably comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.05 to 3 wt.-%, based on the total weight of the composition, of a humectant,
d) from 0.05 to 1.5 wt.-%, based on the total weight of the composition, of a surfactant, and
e) from 0.05 to 1.5 wt.-%, based on the total weight of the composition, of a dispersing agent.

For example, the liquid foliar composition comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.05 to 3 wt.-%, based on the total weight of the composition, of a humectant,
d) from 0.05 to 1.5 wt.-%, based on the total weight of the composition, of a surfactant, and
e) from 0.05 to 1.5 wt.-%, based on the total weight of the composition, of a dispersing agent.

It is appreciated that the liquid foliar composition may further comprise a plant nutrient element, which may be advantageous for improving the growth and/or health of the plant when the liquid foliar composition is applied onto a surface such as a plant surface or fungi surface.

The plant nutrient element may be selected from any plant nutrient element that is typically used in the compositions to be prepared. For example, the plant nutrient element can be selected from the group consisting of zinc, copper, iron, manganese, boron, molybdenum, nitrogen, silicium, sodium, chlorine, phosphorus, potassium, calcium, magnesium, sulphur and mixtures thereof, a pesticide, or sun protection compound.

If present, it is preferred that the liquid foliar composition comprises the plant nutrient element in an amount ranging from 0.01 to 3 wt.-%, based on the total weight of the composition. Preferably, the liquid foliar composition comprises the plant nutrient element in an amount ranging from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition.

In view of this, the liquid foliar composition preferably comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant, and
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a plant nutrient element.

For example, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant, and
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a plant nutrient element.

In the foregoing embodiment, the liquid foliar composition is preferably free of a surfactant.

In one embodiment, the liquid foliar composition comprises a plant nutrient element and a surfactant. That is to say, the liquid foliar composition is preferably free of a surfactant. In this embodiment, the liquid foliar composition preferably comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant, and
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a plant nutrient element.

For example, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant, and
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a plant nutrient element.

In one embodiment, the liquid foliar composition comprises a plant nutrient element, a humectant and a surfactant. In this embodiment, the liquid foliar composition preferably comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant,
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant, and
e) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a plant nutrient element.

For example, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant,
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant, and
e) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a plant nutrient element.

In one embodiment, the liquid foliar composition comprises a plant nutrient element and a dispersing agent. In this embodiment, the liquid foliar composition preferably comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant,
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a dispersing agent, and
e) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a plant nutrient element.

For example, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant,
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a dispersing agent, and
e) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a plant nutrient element.

In an alternative embodiment, the liquid foliar composition preferably comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant,
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a dispersing agent, and
e) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a plant nutrient element.

For example, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant,
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a dispersing agent, and
e) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a plant nutrient element.

In one embodiment, the liquid foliar composition comprises a plant nutrient element, a humectant, a surfactant and a dispersing agent. In this embodiment, the liquid foliar composition preferably comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant,
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant,
e) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a dispersing agent, and
f) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a plant nutrient element.

For example, the liquid foliar composition comprises
a) an aqueous solvent or dispersion medium,
b) from 0.1 to 60 wt.-%, preferably from 0.1 to 50 wt.-%, more preferably from 0.1 to 40 wt.-%, still more preferably from 0.1 to 30 wt.-%, even more preferably from 0.1 to 20 wt.-% and most preferably from 0.1 to 10 wt.-%, based on the total weight of the composition, or from 1 to 60 wt.-%, preferably from 1 to 50 wt.-%, more preferably from 1 to 40 wt.-%, still more preferably from 1 to 30 wt.-%, even more preferably from 1 to 20 wt.-% and most preferably from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.01 to 10 wt.-%, preferable from 0.01 to 8 wt.-%, more preferably from 0.02 to 6 wt.-%, still more preferably from 0.03 to 5 wt.-%, even more preferably from 0.0.4 to 4 wt.-% and most preferably from 0.05 to 3 wt.-%, based on the total weight of the composition, of a humectant,
d) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a surfactant,
e) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a dispersing agent, and
f) from 0.01 to 3 wt.-%, preferable from 0.01 to 2.5 wt.-%, preferably from 0.02 to 2.5 wt.-%, more preferably from 0.03 to 2 wt.-%, even more preferably from 0.04 to 1.8 wt.-% and most preferably from 0.05 to 1.5 wt.-%, based on the total weight of the composition, of a plant nutrient element.

Preferably, the liquid foliar composition preferably comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.05 to 3 wt.-%, based on the total weight of the composition, of a humectant, and
d) from 0.05 to 1.5 wt.-%, based on the total weight of the composition, of a plant nutrient element.

For example, the liquid foliar composition comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.05 to 3 wt.-%, based on the total weight of the composition, of a humectant, and
d) from 0.05 to 1.5 wt.-%, based on the total weight of the composition, of a plant nutrient element.

Alternatively, the liquid foliar composition preferably comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm,
c) from 0.05 to 1.5 wt.-%, based on the total weight of the composition, of a surfactant, and
d) from 0.05 to 1.5 wt.-%, based on the total weight of the composition, of a plant nutrient element.

For example, the liquid foliar composition comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.05 to 1.5 wt.-%, based on the total weight of the composition, of a surfactant, and
d) from 0.05 to 1.5 wt.-%, based on the total weight of the composition, of a plant nutrient element.

In one embodiment, the liquid foliar composition preferably comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm,
c) from 0.05 to 3 wt.-%, based on the total weight of the composition, of a humectant,
d) from 0.05 to 1.5 wt.-%, based on the total weight of the composition, of a surfactant, and
e) from 0.05 to 1.5 wt.-%, based on the total weight of the composition, of a plant nutrient element.

For example, the liquid foliar composition comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.05 to 3 wt.-%, based on the total weight of the composition, of a humectant,
d) from 0.05 to 1.5 wt.-%, based on the total weight of the composition, of a surfactant, and
e) from 0.05 to 1.5 wt.-%, based on the total weight of the composition, of a plant nutrient element.

In one embodiment, the liquid foliar composition preferably comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.05 to 3 wt.-%, based on the total weight of the composition, of a humectant,
d) from 0.05 to 1.5 wt.-%, based on the total weight of the composition, of a dispersing agent, and
e) from 0.05 to 1.5 wt.-%, based on the total weight of the composition, of a plant nutrient element.

For example, the liquid foliar composition comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, wherein the particulate mineral-based material has a weight-based median particle size d₅₀ in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.05 to 3 wt.-%, based on the total weight of the composition, of a humectant,
d) from 0.05 to 1.5 wt.-%, based on the total weight of the composition, of a dispersing agent, and
e) from 0.05 to 1.5 wt.-%, based on the total weight of the composition, of a plant nutrient element.

Alternatively, the liquid foliar composition preferably comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.05 to 1.5 wt.-%, based on the total weight of the composition, of a surfactant,
d) from 0.05 to 1.5 wt.-%, based on the total weight of the composition, of a dispersing agent, and
e) from 0.05 to 1.5 wt.-%, based on the total weight of the composition, of a plant nutrient element.

For example, the liquid foliar composition comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.05 to 1.5 wt.-%, based on the total weight of the composition, of a surfactant,
d) from 0.05 to 1.5 wt.-%, based on the total weight of the composition, of a dispersing agent, and
e) from 0.05 to 1.5 wt.-%, based on the total weight of the composition, of a plant nutrient element.

In one embodiment, the liquid foliar composition preferably comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.05 to 3 wt.-%, based on the total weight of the composition, of a humectant,
d) from 0.05 to 1.5 wt.-%, based on the total weight of the composition, of a surfactant,
e) from 0.05 to 1.5 wt.-%, based on the total weight of the composition, of a dispersing agent, and
f) from 0.05 to 1.5 wt.-%, based on the total weight of the composition, of a plant nutrient element.

For example, the liquid foliar composition comprises
a) an aqueous solvent or dispersion medium,
b) from 0.1 to 10 wt.-% or from 1 to 10 wt.-%, based on the total weight of the composition, of a particulate mineral-based material comprising at least one alkaline earth metal ion-comprising material, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
c) from 0.05 to 3 wt.-%, based on the total weight of the composition, of a humectant,
d) from 0.05 to 1.5 wt.-%, based on the total weight of the composition, of a surfactant,
e) from 0.05 to 1.5 wt.-%, based on the total weight of the composition, of a dispersing agent, and
f) from 0.05 to 1.5 wt.-%, based on the total weight of the composition, of a plant nutrient element.

The liquid foliar composition as defined herein is preferably prepared by a method for its formulation. The method of formulating the liquid foliar composition as defined herein comprises the steps of
a) providing a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
b) providing a humectant and/or surfactant, and
c) dissolving and/or dispersing the particulate mineral-based material and the humectant and/or the surfactant in an aqueous solvent or dispersion medium such that the particulate mineral-based material is present in an amount ranging from 0.1 to 10 wt.-% or from 1 to 60 wt.-%, based on the total weight of the composition, and the humectant is present in an amount ranging from 0.01 to 10 wt.-%, based on the total weight of the composition and/or the surfactant is present in an amount ranging from 0.01 to 3 wt.-%, based on the total weight of the composition.

With regard to the definition of the liquid foliar composition, the particulate mineral-based material, the humectant, the surfactant, the aqueous solvent or dispersion medium and preferred embodiments thereof, reference is made to the statements provided above when discussing the technical details of the liquid foliar composition of the present invention.

It is appreciated that the wording “dissolving” in the meaning of the present invention refers to a step in which no solids are detectable in the liquid foliar composition to be prepared. The wording “dispersing” in the meaning of the present invention refers to a step in which all of the solids added to the aqueous medium are still detectable in the liquid foliar composition to be prepared. That is to say, no solids are dissolved in the aqueous medium. The wording “dissolving and dispersing” in the meaning of the present invention refers to a step in which a part of the solids is still detectable in the liquid foliar composition to be prepared, while the other part is dissolved in the aqueous medium.

It is preferred that step c) is preferably performed by dissolving and dispersing the particulate mineral-based material and the humectant and/or the surfactant in the aqueous solvent or dispersion medium. For example, step c) is preferably performed by dissolving and dispersing the particulate mineral-based material and the humectant in the aqueous solvent or dispersion medium, i.e. in the absence of a surfactant. Alternatively, step c) is preferably performed by dissolving and dispersing the particulate mineral-based material and the surfactant in the aqueous solvent or dispersion medium, i.e. in the absence of a humectant. Preferably, step c) is performed by dissolving and dispersing the particulate mineral-based material and the humectant and the surfactant in the aqueous solvent or dispersion medium.

Step c) is preferably performed by mixing the particulate mineral-based material of step a), with the aqueous solvent or dispersion medium. It is appreciated that any mixing (or stirring) means may be used that is suitable to thoroughly mix the components with each other. Suitable equipment for mixing, agitation or stirring is known to the skilled person.

Step c) may be performed at room temperature, i.e. at a temperature of 20° C.±2° C., or at a temperature above the freezing point of the composition prepared in step c). For example, step c) is performed at a temperature of 1 to 50° C., preferably 5 to 45° C.

It is appreciated that the particulate mineral-based material and the humectant and/or the surfactant can be dissolved and/or dispersed in the aqueous solvent or dispersion medium in any order. For example, the particulate mineral-based material is dissolved and/or dispersed first in the aqueous solvent or dispersion medium, followed by the humectant and/or the surfactant that is/are subsequently added to the aqueous solvent or dispersion medium comprising the particulate mineral-based material. In another embodiment, the humectant and/or the surfactant is/are dissolved and/or dispersed first in the aqueous solvent or dispersion medium, followed by the particulate mineral-based material that is subsequently added to the aqueous solvent or dispersion medium comprising the humectant. In another embodiment, the humectant and/or the surfactant and the particulate mineral-based material are mixed first and the mixture is subsequently dissolved and/or dispersed in the aqueous solvent or dispersion medium.

As mentioned above, the liquid foliar composition can comprise a dispersing agent, a plant nutrient element and mixtures thereof. In this embodiment, the method of formulating the liquid foliar composition as defined herein comprises the steps of
a) providing a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm,
b) providing a humectant and/or a surfactant, and
b1) providing a dispersing agent, and/or
b2) providing a plant nutrient element, and
c) dissolving and/or dispersing the particulate mineral-based material, the humectant and the optional surfactant and/or the optional dispersing agent and/or the optional plant nutrient element in an aqueous solvent or dispersion medium such that the particulate mineral-based material is present in an amount ranging from 0.1 to 10 wt.-% or from 1 to 60 wt.-%, based on the total weight of the composition, and the humectant is present in an amount ranging from 0.01 to 10 wt.-%, based on the total weight of the composition, and/or the surfactant is present in an amount ranging from 0.01 to 3 wt.-%, based on the total weight of the composition, and/or the optional dispersing agent is present in an amount ranging from 0.01 to 3 wt.-%, based on the total weight of the composition, and/or the optional plant nutrient element is present in an amount ranging from 0.01 to 3 wt.-%, based on the total weight of the composition.

It is appreciated that the particulate mineral-based material, the humectant and/or the surfactant and/or the optional dispersing agent and/or the optional plant nutrient element can be dissolved and/or dispersed in the aqueous solvent or dispersion medium in any order. For example, the particulate mineral-based material is dissolved and/or dispersed first in the aqueous solvent or dispersion medium, followed by the humectant and/or the surfactant and/or the optional dispersing agent and/or the optional plant nutrient element that are subsequently added to the aqueous solvent or dispersion medium comprising the particulate mineral-based material. In one embodiment, the humectant and/or the surfactant is/are dissolved and/or dispersed first in the aqueous solvent or dispersion medium, followed by the particulate mineral-based material and the optional dispersing agent and/or the optional plant nutrient element that are subsequently added to the aqueous solvent or dispersion medium comprising the humectant and/or the surfactant. In one embodiment, the optional dispersing agent and/or the optional plant nutrient element is/are dissolved and/or dispersed first in the aqueous solvent or dispersion medium, followed by the particulate mineral-based material and the humectant and/or the surfactant that are subsequently added to the aqueous solvent or dispersion medium comprising the optional dispersing agent and/or the optional plant nutrient element. In one embodiment, the humectant and/or the surfactant and the particulate mineral-based material are mixed first, and the mixture is subsequently dissolved and/or dispersed in the aqueous solvent or dispersion medium, followed by the optional dispersing agent and/or the optional plant nutrient element that is/are subsequently added to the aqueous solvent or dispersion medium comprising the humectant and the particulate mineral-based material. In one embodiment, the humectant and/or the surfactant and/or the optional dispersing agent and/or the optional plant nutrient element are mixed first, and the mixture is subsequently dissolved and/or dispersed in the aqueous solvent or dispersion medium, followed by the particulate mineral-based material that is subsequently added to the aqueous solvent or dispersion medium comprising the humectant and/or the surfactant and/or the optional dispersing agent and/or the optional plant nutrient element. In one embodiment, the particulate mineral-based material and the optional dispersing agent and/or the optional plant nutrient element are mixed first, and the mixture is subsequently dissolved and/or dispersed in the aqueous solvent or dispersion medium, followed by the humectant and/or the surfactant that is/are subsequently added to the aqueous solvent or dispersion medium comprising the particulate mineral-based material and the optional dispersing agent and/or the optional plant nutrient element.

In one embodiment, the liquid foliar composition further comprises a surfactant. In this embodiment, the method of formulating the liquid foliar composition as defined herein comprises the steps of
a) providing a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
b) providing a humectant and a surfactant, and
c) dissolving and/or dispersing the particulate mineral-based material, the humectant and the surfactant in an aqueous solvent or dispersion medium such that the particulate mineral-based material is present in an amount ranging from 0.1 to 10 wt.-% or from 1 to 60 wt.-%, based on the total weight of the composition, and the humectant is present in an amount ranging from 0.01 to 10 wt.-%, based on the total weight of the composition, and the surfactant is present in an amount ranging from 0.01 to 3 wt.-%, based on the total weight of the composition.

In another embodiment, the liquid foliar composition further comprises a dispersing agent. It is appreciated that a dispersing agent is preferably used if step c) includes a step of dispersing or dissolving and dispersing the particulate mineral-based material and the humectant and/or the surfactant in the aqueous solvent or dispersion medium. In this embodiment, the method of formulating the liquid foliar composition as defined herein comprises the steps of
a) providing a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
b) providing a humectant and/or a surfactant,
b1) providing a dispersing agent, and
c) dissolving and/or dispersing the particulate mineral-based material, the humectant and the dispersing agent in an aqueous solvent or dispersion medium such that the particulate mineral-based material is present in an amount ranging from 0.1 to 10 wt.-% or from 1 to 60 wt.-%, based on the total weight of the composition, and the humectant is present in an amount ranging from 0.01 to 10 wt.-%, based on the total weight of the composition, and/or the surfactant is present in an amount ranging from 0.01 to 3 wt.-%, based on the total weight of the composition and the dispersing agent is present in an amount ranging from 0.01 to 3 wt.-%, based on the total weight of the composition.

In another embodiment, the liquid foliar composition further comprises a plant nutrient element. In this embodiment, the method of formulating the liquid foliar composition as defined herein comprises the steps of
a) providing a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
b) providing a humectant and/or a surfactant, and
b2) providing a plant nutrient element, and
c) dissolving and/or dispersing the particulate mineral-based material, the humectant and the plant nutrient element in an aqueous solvent or dispersion medium such that the particulate mineral-based material is present in an amount ranging from 0.1 to 10 wt.-% or from 1 to 60 wt.-%, based on the total weight of the composition, and the humectant is present in an amount ranging from 0.01 to 10 wt.-%, based on the total weight of the composition, and/or the surfactant is present in an amount ranging from 0.01 to 3 wt.-%, based on the total weight of the composition and the plant nutrient element is present in an amount ranging from 0.01 to 3 wt.-%, based on the total weight of the composition.

In another embodiment, the liquid foliar composition comprises a humectant, a surfactant and a dispersing agent. In this embodiment, the method of formulating the liquid foliar composition as defined herein comprises the steps of
a) providing a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
b) providing a humectant and a surfactant,
b1) providing a dispersing agent, and
c) dissolving and/or dispersing the particulate mineral-based material, the humectant and the surfactant and the dispersing agent in an aqueous solvent or dispersion medium such that the particulate mineral-based material is present in an amount ranging from 0.1 to 10 wt.-% or from 1 to 60 wt.-%, based on the total weight of the composition, and the humectant is present in an amount ranging from 0.01 to 10 wt.-%, based on the total weight of the composition, and the surfactant is present in an amount ranging from 0.01 to 3 wt.-%, based on the total weight of the composition, and the dispersing agent is present in an amount ranging from 0.01 to 3 wt.-%, based on the total weight of the composition.

In another embodiment, the liquid foliar composition comprises a humectant, a surfactant and a plant nutrient element. In this embodiment, the method of formulating the liquid foliar composition as defined herein comprises the steps of
a) providing a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
b) providing a humectant and a surfactant, and
b2) providing a plant nutrient element, and
c) dissolving and/or dispersing the particulate mineral-based material, the humectant and the surfactant and the plant nutrient element in an aqueous solvent or dispersion medium such that the particulate mineral-based material is present in an amount ranging from 0.1 to 10 wt.-% or from 1 to 60 wt.-%, based on the total weight of the composition, and the humectant is present in an amount ranging from 0.01 to 10 wt.-%, based on the total weight of the composition, and the surfactant is present in an amount ranging from 0.01 to 3 wt.-%, based on the total weight of the composition, and the plant nutrient element is present in an amount ranging from 0.01 to 3 wt.-%, based on the total weight of the composition.

In another embodiment, the liquid foliar composition comprises a dispersing agent and a plant nutrient element and mixtures thereof. In this embodiment, the method of formulating the liquid foliar composition as defined herein comprises the steps of
a) providing a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
b) providing a humectant and/or surfactant,
b1) providing a dispersing agent,
b2) providing a plant nutrient element, and
c) dissolving and/or dispersing the particulate mineral-based material, the humectant and/or the surfactant, and the dispersing agent and the plant nutrient element in an aqueous solvent or dispersion medium such that the particulate mineral-based material is present in an amount ranging from 0.1 to 10 wt.-% or from 1 to 60 wt.-%, based on the total weight of the composition, and the humectant is present in an amount ranging from 0.01 to 10 wt.-%, based on the total weight of the composition, and/or the surfactant is present in an amount ranging from 0.01 to 3 wt.-%, based on the total weight of the composition and the dispersing agent is present in an amount ranging from 0.01 to 3 wt.-%, based on the total weight of the composition, and the plant nutrient element is present in an amount ranging from 0.01 to 3 wt.-%, based on the total weight of the composition.

In one embodiment, the liquid foliar composition comprises a humectant, a surfactant, a dispersing agent and a plant nutrient element. In this embodiment, the method of formulating the liquid foliar composition as defined herein comprises the steps of
a) providing a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method,
b) providing a humectant and a surfactant,
b1) providing a dispersing agent,
b2) providing a plant nutrient element, and
c) dissolving and/or dispersing the particulate mineral-based material, the humectant, the surfactant, the dispersing agent and the plant nutrient element in an aqueous solvent or dispersion medium such that the particulate mineral-based material is present in an amount ranging from 0.1 to 10 wt.-% or from 1 to 60 wt.-%, based on the total weight of the composition, and the humectant is present in an amount ranging from 0.01 to 10 wt.-%, based on the total weight of the composition, and the surfactant is present in an amount ranging from 0.01 to 3 wt.-%, based on the total weight of the composition, and the dispersing agent is present in an amount ranging from 0.01 to 3 wt.-%, based on the total weight of the composition, and the plant nutrient element is present in an amount ranging from 0.01 to 3 wt.-%, based on the total weight of the composition.

With regard to the definition of the dispersing agent, the plant nutrient element and preferred embodiments thereof, reference is made to the statements provided above when discussing the technical details of the liquid foliar composition of the present invention.

### Method for Increasing the Wettability of a Surface and Uses

According to a further aspect of the present invention, the liquid foliar composition as defined herein is used in a method for increasing the wettability of a surface.

Thus, the present invention further relates to a method of increasing the wettability of a surface, the method comprising the steps of
a) providing a liquid foliar composition as defined herein, and
b) applying the liquid foliar composition to the surface.

With regard to the definition of the liquid foliar composition and preferred embodiments thereof, reference is made to the statements provided above when discussing the technical details of the liquid foliar composition of the present invention.

The wording “increasing the wettability” according to the present invention means that the contact angle of the surface to which the foliar composition is applied is after application at least 20°, more preferably at least 30°, even more preferably at least 40° and most preferably at least 50°, below the contact angle of the untreated surface, i.e. the surface before applying the foliar composition. Additionally or alternatively, the contact angle of the surface to which the foliar composition is applied remains stable. That is to say, the contact angle of the surface to which the foliar composition is applied decreases and/or increases by less than 20°, more preferably by less than 15° and most preferably by less than 12°, after 1 to 10, preferably after 1 to 8, more preferably after 1 to 5, washing(s), wherein the decrease and/or increase of the contact angle after the washing(s) is compared to the contact angle after application of the foliar composition, i.e. without washing.

It is appreciated that the surface onto which the liquid foliar composition is applied is preferably a plant surface or fungi surface.

In a preferred embodiment, the method of increasing the wettability of a surface thus comprises the steps of
a) providing a liquid foliar composition as defined herein, and
b) applying the liquid foliar composition to a plant surface or fungi surface.

It is to be noted that the liquid foliar composition can be applied to the surface by any method known in the art. For example, the liquid foliar composition can be applied to the surface by spraying, fogging, dropping, dipping, brushing, and the like. Preferably, the liquid foliar composition is applied to the surface by spraying.

It is appreciated that the liquid foliar composition is preferably applied to a plant or fungi surface, preferably food crops and ornamentals plants and most preferably food crops and ornamentals plants having rather hydrophobic leaf surface characteristics. The wording “hydrophobic leaf surface” according to the present invention means that the leaf surface has a static water contact angle 8 equal or greater than 80°. Preferably, the leaf surface has a static water contact angle 8 ranging from 80° to 180°, more preferably from 80° to 150°.

In one embodiment, the leaf surface has a static water contact angle 8 equal or greater than 150°, e.g. from 150° to 180°.

In view of the advantageous effect obtained for the present invention, another aspect of the present application further refers to the use of the liquid foliar composition as defined in herein in agricultural and horticultural applications.

With regard to the definition of the liquid foliar composition and preferred embodiments thereof, reference is made to the statements provided above when discussing the technical details of the liquid foliar composition of the present invention.

A further aspect of the present invention relates to the use of a particulate mineral-based material comprising at least one alkaline earth metal ion-comprising material, iron oxide or zinc oxide in a liquid foliar composition, wherein the particulate mineral-based material has a weight-based median particle size d₅₀ value in the range from 5 nm to 20 μm, wherein particles having a weight-based median particle size d₅₀ of 1 μm are measured by the sedimentation method and particles having a weight-based median particle size d₅₀ of <1 μm are measured by the dynamic light scattering method.

In a preferred embodiment, the particulate mineral-based material combined with a humectant and/or a surfactant provides an increased wettability in combination with a long-lasting effect for a surface on which the liquid foliar composition is applied. For example, the particulate mineral-based material combined with the humectant and/or the surfactant provides an increased wettability in combination with a long-lasting effect for a plant surface or fungi surface on which the liquid foliar composition is applied. Most preferably, the particulate mineral-based material combined with the humectant and the surfactant provides an increased wettability in combination with a long-lasting effect for a surface on which the liquid foliar composition is applied. For example, the particulate mineral-based material combined with the humectant and the surfactant provides an increased wettability in combination with a long-lasting effect for a plant surface or fungi surface on which the liquid foliar composition is applied.

With regard to the definition of the liquid foliar composition, the particulate mineral-based material, the humectant, the surfactant and preferred embodiments thereof, reference is made to the statements provided above when discussing the technical details of the liquid foliar composition of the present invention.

The following examples and tests will illustrate the present invention, but are not intended to limit the invention in any way.

### BRIEF DESCRIPTION OF THE FIGURES

FIG. 1 shows the contact angle measurement for formulation A

FIG. 2 shows the contact angle measurement for formulation B

FIG. 3 shows the contact angle measurement for formulation C

FIG. 4 shows the contact angle measurement for formulation D

FIG. 5 shows the contact angle measurement for formulations A, B and C after each rain

FIG. 6 shows the contact angle measurement of nano slurries with humectant, with Genapol as surfactant and with combination of both (surfactant and humectant)

FIG. 7 shows the contact angle measurement of nano slurries with humectant, with Break-Thru as surfactant and with combination of both (surfactant and humectant)

FIG. 8 shows the contact angle measurement of nano slurries with CaCl₂) or glycerol as humectant in combination with surfactant

FIG. 9 shows the contact angle measurement for different nanoparticle-based coatings

### EXAMPLES

### I. Analytical Methods

### BET Specific Surface Area of a Material

Throughout the present document, the specific surface area (in m²/g) of the mineral filler was determined using the BET method (using nitrogen as adsorbing gas), which is well known to the skilled man (ISO 9277:2010). The total surface area (in m²) of the mineral filler was then obtained by multiplication of the specific surface area and the mass (in g) of the mineral filler prior to treatment.

Particle Size Distribution (Mass % Particles with a Diameter <X) and Weight Median Diameter (d₅₀) of a Particulate Material

As used herein and as generally defined in the art, the “d₅₀” and “d₉₈” values for particles having a weight-based median particle size d₅₀ of 1 μm were measured by the sedimentation method, which is an analysis of sedimentation behaviour in a gravimetric field. The measurement was made with a Sedigraph™ 5120 of Micromeritics Instrument Corporation, USA.

The measurement is carried out in an aqueous solution of 0.1 wt. % Na₄P₂O₇. The samples are dispersed using a high speed stirrer and sonication.

For particles having a weight-based median particle size d₅₀ of <1 μm, the weight-based median particle size d₅₀ and top cut d₉₈ values were evaluated using a Malvern Zetasizer ZS90 Dynamic Light Scattering System. The raw data obtained by the measurement are analyzed using the Mie theory, with a particle refractive index of 1.57 and an absorption index of 0.01.

### OCA (Optical Contact Angle) Measurement

Equipment: optical contact angle (OCA 50), dataphysics.

Tested liquid: deionized water

Table tilt angle: 0°

Drop size: 2 μL

Mode: Sessile drop technique

Syringe external diameter: 0.52 mm

The OCA was composed of an optical set up lenses, lamp, dosing system, video camera, movable stage X, Y and Z direction and tilt table (0-95°, inclination).

The OCA was an instrument with dosing system, camera, stage, tilted table and a software SCA-20 that helped to manipulate the instrument. The software also supported the analysis of the average contact angle of the drop on the surface.

The surface of interest was positioned and fixed on the stage under the dosing system. Deionized water was loaded into the dosing system and drops of 2 μL were dispensed on the surface of interest. The base diameter of the drop displayed on screen was suggested to be less than the % of the field view. The drop was recorded during the deposition and the evaluation was performed from the recorded video while the table was in horizontal position. The average contact angle (left and right contact angle) was measured using circle (less than 30°) or ellipse fitting (between 30-60°). The data were evaluated until the contour of the drop was visible.

### II. Examples

### Example 1

Materials used:
support plate: sandblasted PMMA plates (50×50 mm)
surfactant: Break Thru (0.25 g)
particulate mineral-based material: ground calcium carbonate (GCC)
   micro GCC: BET 1-2 m²/g, d₅₀=3-4 μm, d₉₈=9-10 μm
   nano GCC: BET 30-40 m²/g, d₅₀=60-70 nm, d₉₈=140-150 nm
Humectant: CaCl₂) (150 mM)

Method used:
Coating: spray coating, working distance 30 cm, final coating weight approximately 14 mg per plate
Rinsing: 5 ml deionized H₂O per rinsing step and plate, applied with a pipette
Contact angle measurement: sessile drop technique, drop size 2 μl

The formulations used for the trials are set out in the following table 1.

TABLE 1

| | Formulation | | | |
|---|---|---|---|---|
| | A | B | C | D |
| Nano GCC (5 g) | X | X | | |
| Micro GCC (5 g) | | | X | X |
| Humectant | X | X | X | X |
| (CaCl₂ 150 mM, 245 g) | | | | |
| Surfactant | X | | X | |
| (Break-Thru, 0.25 g) | | | | |

The results obtained in example 1 are shown in the following table 2.

TABLE 2

| | Rinsing steps | | Contact |
|---|---|---|---|
| Formulation | (no.) | Time (s) | angle (°) |
| None (uncoated support plate) | 0 | 300 | 83 |
| Formulation D | 0 (initial) | 273 | 12 |
| Formulation D | 3 (middle) | 300 | 50 |
| Formulation D | 5 (final) | 300 | 60 |
| Formulation C | 0 (initial) | 1 | 6 |
| Formulation C | 3 (middle) | 0.75 | 13.4 |
| Formulation C | 5 (final) | 6.45 | 10 |
| Formulation B | 0 (initial) | 109 | 10 |
| Formulation B | 3 (middle) | 0.15 | 12.7 |
| Formulation B | 5 (final) | 0.35 | 13 |
| Formulation A | 0 (initial) | 0.5 | 6.4 |
| Formulation A | 3 (middle) | 0.45 | 7 |
| Formulation A | 5 (final) | 0.15 | 10 |

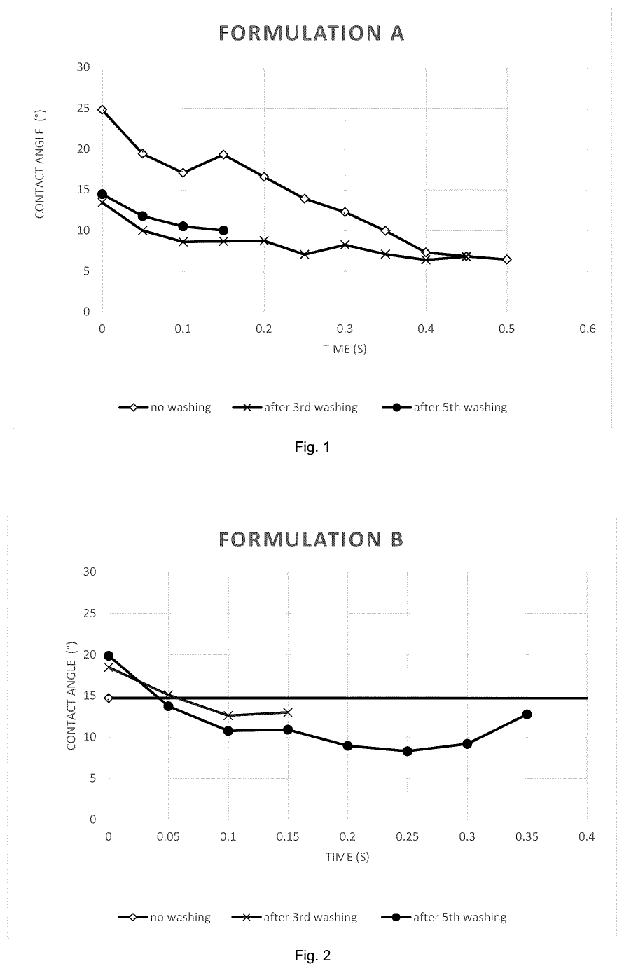

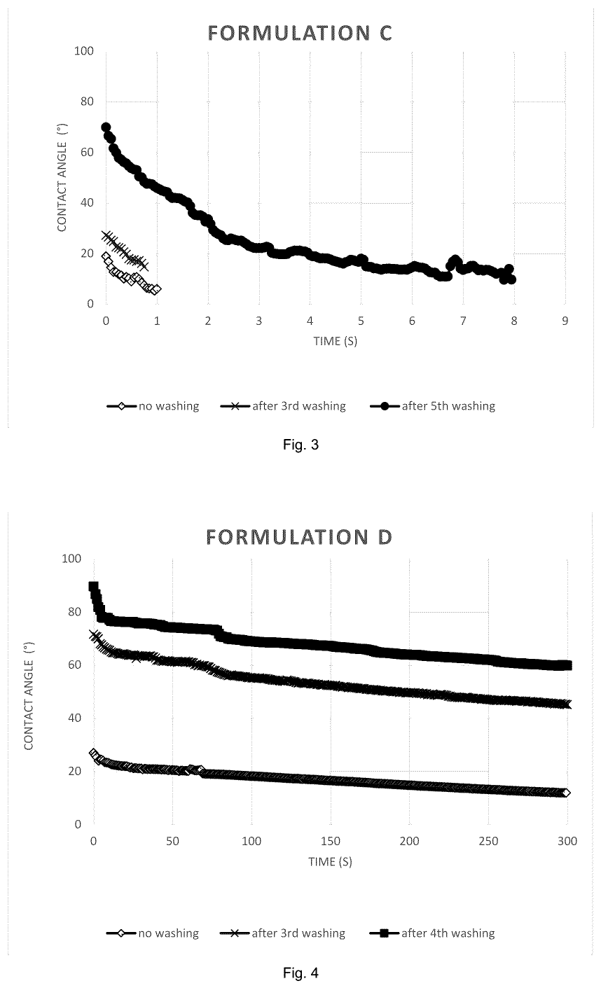

Optical contact angle was measured after 0, 3 and 5 rinsing steps and compared to the uncoated base material. Results show that nano particles without surfactant (formulation B) have the same effect as formulations with surfactant independent of the particle size (formulation A and C). The results below the evolution of the contact angle are shown for each formulation in FIGS. 1, 2, 3 and 4.

### Example 2

Formulations A, B and C as set out in Table 1 above were used.

### Method Used:

Coating: spray coating, working distance 30 cm, final coating weight approximately 14 mg per plate
Rinsing: 1360 ml tap H₂O per rinsing step and plate, applied with a rain machine
Contact angle measurement: sessile drop technique, drop size 2 μl

The three formulations A, B and C showed low contact angles in example 1 and thus an additional trial was performed for formulations A, B and C. In particular, the contact angle for formulations A, B and C was measured after each of numerous washing steps. The rinsing procedure was adjusted towards realistic conditions in the field.

Results show that wetting properties remained very good on the formulations with nano particles (A and B) whereas they got lost with micro particles (formulation C). Additionally, measurements on plates without particles were performed to show specifically the effect of the particles (surfactant).

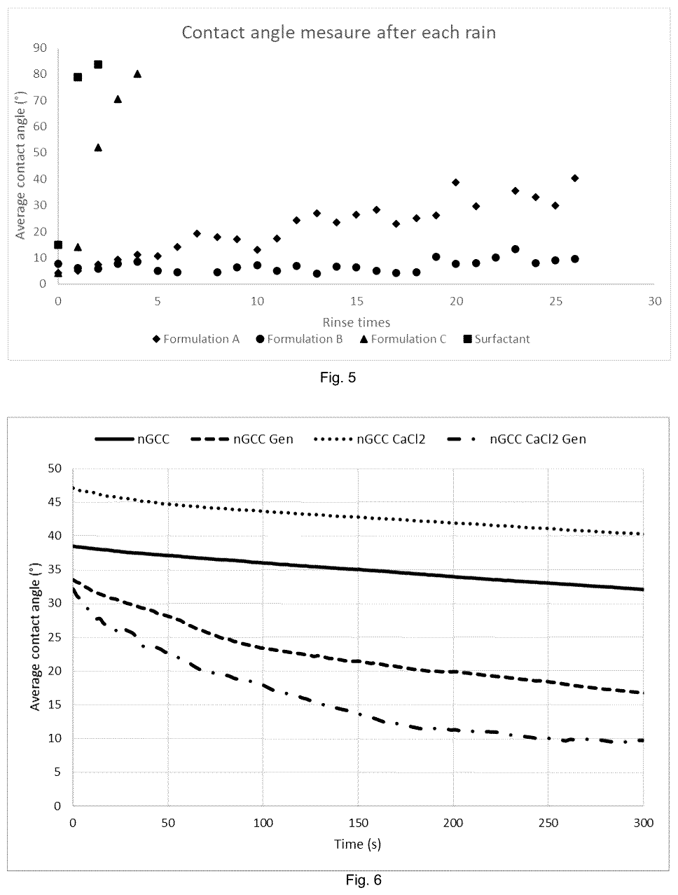

The results are shown in FIG. 5.

### Example 3

The following example shows the synergistic effect of humectants and surfactants in combination with the particulate mineral-based material.

### Materials

### Surfactants

Genapol X-080 (Gen; nonionic surfactant; isotridecyl polyethylene glycol ether)
Break-Thru S 240 (BT; nonionic surfactant; polyether trisiloxane)

### Mineral

GCC nanoparticles (BET=38 m²/g, d₅₀=135 nm, d₉₈₌₃₄₀ nm)

### Humectants

CaCl₂)
Glycerol

### Support Plate

Mica grade V1 (Mica grade V1)

### Description of Experiment on Optical Contact Angle (OCA) and Results

The contact angle of different formulations (see Table 3) on a mica surface was measured.

The formulations were loaded in a syringe and 5 μl of slurry were deposited as fast as possible (less than 1 min after loading into the syringe) on the mica surface. Left and right angle of the drop in contact with the mica was tracked over time. Typically, the contact angles were measured until 300 s but, in some cases, the slurry formulation reached very low contact angles in shorter time.

TABLE 3
Slurries ID and composition

| | | | | | nGCC | nGCC | | nGCC |
|---|---|---|---|---|---|---|---|---|
| | | nGCC | nGCC | nGCC | CaCl2 | CaCl2 | nGCC | Glycerol |
| | nGCC | BT | Gen | CaCl2 | BT | Gen | Glycerol | BT |
| GCC nanoparticles (1.25 g) | X | X | X | X | X | X | X | X |
| Deionized water (248.75 g) | X | X | X | | | | | |
| CaCl₂ humectant dissolved in | | | | X | X | X | | |
| deion. water (150 mM, 248.75 | | | | | | | | |
| g)* | | | | | | | | |
| Glycerol humectant dissolved | | | | | | | X | X |
| in water (1 wt %, 248.75 g)** | | | | | | | | |
| Surfactant | | X | | | X | | | X |
| (Break-Thru, 0.25 g) | | | | | | | | |
| Surfactant | | | X | | | X | | |
| (Genapol, 0.25 g) | | | | | | | | |

*4.16 g of CaCl₂ in 250 g of deionized water. In the final formulation including the mineral, it corresponds to 1.6 wt.-%.
**2.5 g of glycerol in 247.5 g of deionized water. In the final formulation including the mineral, it corresponds to 1 wt.-%.

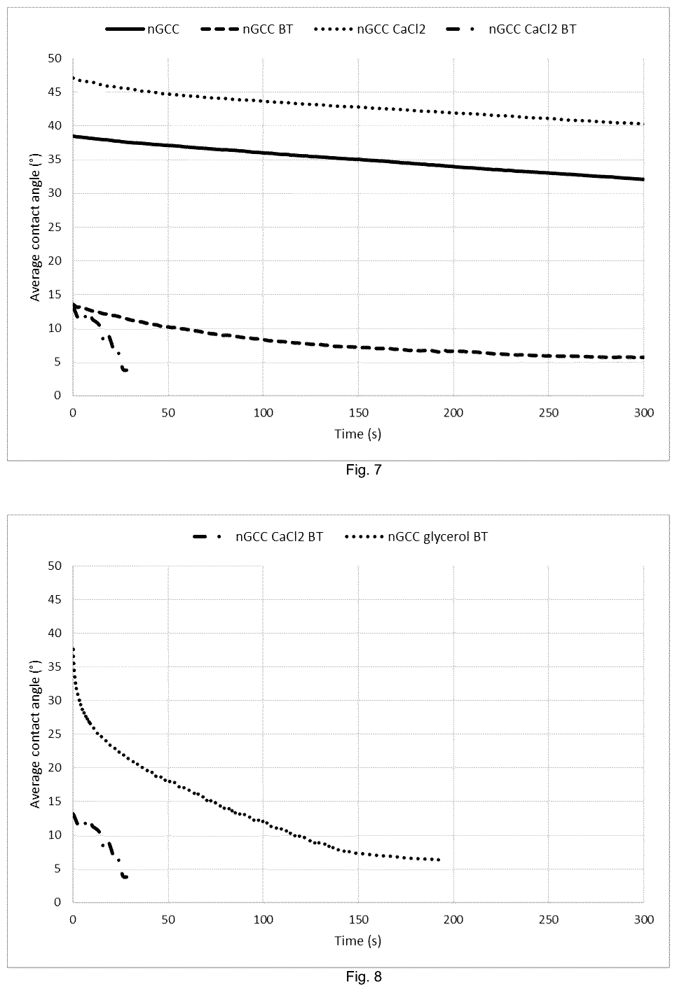

Two surfactants were evaluated, namely Break-Thru and Genapol. The contact angle of the nano slurries with humectant, with surfactant and with combination of both (surfactant and humectant) is shown in FIG. 6 for Genapol and in FIG. 7 for Break-Thru.

A synergy of the humectant with both surfactants is observed, as indicated by the lower contact angle of the full formulation (nGCC+CaCl₂)(humectant)+Surfactant) compared to the formulation containing only particles (nGCC), or “particles+humectant” (nGCC+CaCl₂)), or “particles+surfactant” (nGCC+Surfactant).

### Example 4

The following example shows the efficiency of using different humectants in combination with the particulate mineral-based material and surfactant.

### Materials

### Surfactant

Break-Thru S 240 (BT; nonionic surfactant; polyether trisiloxane)

### Mineral

GCC nanoparticles (BET=38 m²/g, d₅₀=135 nm, d₉₈₌₃₄₀ nm)

### Humectants

CaCl₂)
Glycerol

### Support Plate

Mica grade V1 (Mica grade V1)

Replacement of CaCl₂) with glycerol was evaluated. The contact angle of the nano slurries with a combination of humectant and surfactant is shown in FIG. 8 for CaCl₂) and glycerol. The compositions correspond to the compositions set out in table 3 above.

Replacing CaCl₂) with glycerol has the same qualitative effect on the measured contact angle: CA of (nGCC Glycerol BT) is only slightly lower compared to that of (nGCC BT).

### Example 5

The following example shows the effect of iron oxides on the contact angle.

### Materials

### Surfactant

Break-Thru S 240 (BT; nonionic surfactant; polyether trisiloxane)

### Minerals

GCC nanoparticles (nano-GCC; BET=38 m²/g, d₅₀₌₁₃₅ nm, d₉₈₌₃₄₀ nm)
GCC microparticles (micro-GCC; BET=1-2 m²/g, d₅₀₌₃-4 μm, d₉₈₌₉-10 μm)
Fe₃O₄ nanoparticles (nano-Fe₃O₄; product no. 637106, Sigma Aldrich; BET=8 m²/g, d₅₀=120 nm, d₉₈₌₅₀₀ nm)

### Humectant

CaCl₂)

### Support Plate

Sandblasted PMMA plate

### Description of Experiment on Optical Contact Angle (OCA) and Results

A rough PMMA plate was spray-coated with the formulations listed in Table 4 below. Final weight of the dried coatings is about 14 mg. About 2 μl of water were deposited on the prepared coatings. Left and right contact angle of the drop were measured. Measurements were performed also after rinsing the coated plates 5 times with a rain simulator. The rain simulator was set in such a way to simulate a heavy European rain event of 50 mm.

TABLE 4
Slurries ID and composition

| | Formulation | | |
|---|---|---|---|
| | nano-GCC | micro-GCC | nano-Fe₃O₄ |
| Nano GCC (5 g) | x | | |
| Micro GCC (5 g) | | x | |
| Nano Fe₃O₄ (5 g) | | | x |
| Humectant dissolved in deion. | x | x | x |
| water | | | |
| (CaCl₂ 150 mM, 245 g)* | | | |
| Surfactant | x | x | x |
| (Break-Thru, 0.25 g) | | | |

*4.16 g of CaCl₂ in 250 g of deionized water. In the final formulation including the mineral, it corresponds to 1.6 wt.-%.

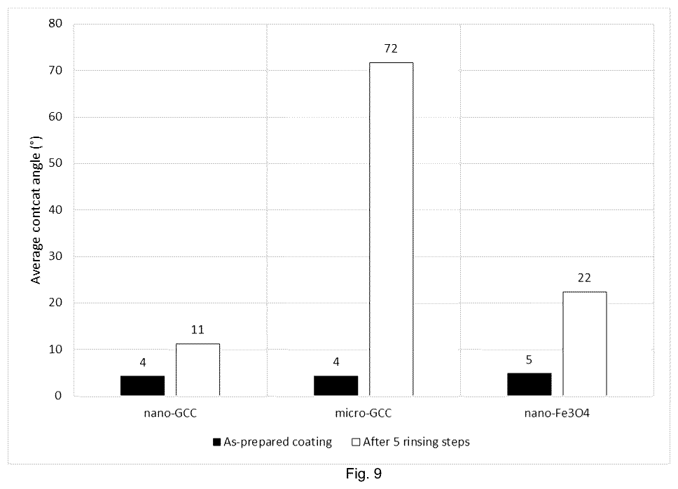

The water contact angle values measured on the as-prepared coatings are low for all formulations and comprised in the range 4-5°. After rinsing, however, the evolution of the contact angle is different and likely related to the chemical composition. For the GCC case, the microparticle-based coating shows a steep increase of the contact angle up to 72°, while this is much less for the nanoparticle-based coating. For the Fe₃O₄ case, the contact angle of the nanoparticle-based coating increases up to 22°. The results are shown in FIG. 9. It is to be noted that the same results as for Fe₃O₄ would be obtained for Fe₂O₃ with similar particle size (for example, Fe₂O₃ nanoparticles (nano-Fe₂O₃, product no. 544884, Sigma Aldrich; BET=50-245 m²/g, particle size <=50 nm). Thus, Fe₃O₄ can be replaced with Fe₂O₃ and vice versa without a loss of effectiveness.

1. Liquid foliar composition comprising
a) an aqueous solvent or dispersion medium,
b) from 0.1 to 60 wt.-%, based on the total weight of the composition, of a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of ≥1 μm are measured by the sedimentation method and particles having a weight-based median particle size d₅₀ of <1 μm are measured by the dynamic light scattering method, and
c) from 0.01 to 10 wt.-%, based on the total weight of the composition, of a humectant, and/or
d) from 0.01 to 3 wt.-%, based on the total weight of the composition, of a surfactant.

2. The liquid foliar composition according to claim 1, wherein the particulate mineral-based material has
a) a weight-based median particle size d₅₀ value in the range from 10 nm to 10 μm, wherein particles having a weight-based median particle size d₅₀ of ≥1 μm are measured by the sedimentation method and particles having a weight-based median particle size d₅₀ of <1 μm are measured by the dynamic light scattering method, and/or
b) a weight-based top cut d₉₈ in the range from 50 nm to 100 μm, wherein particles having a weight-based median particle size d₅₀ of ≥1 μm are measured by the sedimentation method and particles having a weight-based median particle size d₅₀ of <1 μm are measured by the dynamic light scattering method, and/or
c) a BET specific surface area of from 1 to 250 m²/g, measured using nitrogen and the BET method according to ISO 9277:2010.

3. The liquid foliar composition according to claim 1, wherein the particulate mineral-based material comprises alkaline earth metal carbonates, alkaline earth metal phosphates, alkaline earth metal sulphates, alkaline earth metal oxides, alkaline earth metal hydroxides and mixtures thereof.

4. The liquid foliar composition according to claim 1, wherein
i) the particulate mineral-based material comprises at least one calcium ion-comprising material,
ii) the particulate mineral-based material comprises at least one magnesium ion-comprising material, or
iii) the particulate mineral-based material comprises at least one calcium ion-comprising material and at least one magnesium ion-comprising material.

5. The liquid foliar composition according to claim 1, wherein the humectant is an organic-based humectant or an inorganic salt comprising zinc cations, potassium cations, magnesium cations, calcium cations, chloride anions and mixtures thereof.

6. The liquid foliar composition according to claim 1, wherein the surfactant is selected from the group consisting of cationic surfactants, anionic surfactants, nonionic surfactants and mixtures thereof.

7. The liquid foliar composition according to claim 1, wherein the composition further comprises a dispersing agent.

8. The liquid foliar composition according to claim 7, wherein the dispersing agent is present in an amount ranging from 0.01 to 3 wt.-%, based on the total weight of the composition.

9. The liquid foliar composition according to claim 1, wherein the composition further comprises a pesticide, sun protection compound, and/or a plant nutrient element selected from the group consisting of zine, copper, iron, manganese, boron, molybdenum, nitrogen, silicium, sodium, chlorine, phosphorus, potassium, calcium, magnesium, sulphur and mixtures thereof.

10. A method of formulating a liquid foliar composition comprising the steps of
a) providing a particulate mineral-based material comprising at least one alkaline earth metal ion-comprising material, iron oxide or zinc oxide, wherein the particulate mineral-based material has a weight-based median particle size d₅₀ value in the range from 5 nm to 20 μm, wherein particles having a weight-based median particle size d₅₀ of ≥1 μm are measured by the sedimentation method and particles having a weight-based median particle size d₅₀ of <1 μm are measured by the dynamic light scattering method,
b) providing a humectant and/or a surfactant, and
c) dissolving and/or dispersing the particulate mineral-based material and the humectant and/or the surfactant in an aqueous solvent or dispersion medium such that the particulate mineral-based material is present in an amount ranging from 0.1 to 60 wt.-%, based on the total weight of the composition, and the humectant is present in an amount ranging from 0.01 to 10 wt.-%, based on the total weight of the composition and/or the surfactant is present in an amount ranging from 0.01 to 3 wt.-%, based on the total weight of the composition.

11. The method according to claim 10, wherein step c) further comprises dispersing a dispersing agent in the aqueous solvent or dispersion medium such that the dispersing agent is present in an amount ranging from 0.01 to 3 wt.-%, based on the total weight of the composition.

12. A method of increasing the wettability of a surface, the method comprising the steps of
a) providing a liquid foliar composition as defined in claim 1, and
b) applying the liquid foliar composition to the surface.

13. A method of using a liquid foliar composition, comprising the steps of: a) providing the liquid foliar composition as defined in claim 1 in an agricultural and horticultural application, and b) applying the liquid foliar composition to a surface, wherein the surface is a plant surface or a fungi surface.

14. The method according to claim 13, wherein the liquid foliar composition comprises a particulate mineral-based material comprising at least one alkaline earth metal ion-comprising material, iron oxide or zinc oxide, wherein the particulate mineral-based material has a weight-based median particle size d₅₀ value in the range from 10 nm to 10 μm and a weight-based top cut d₉₈ in the range from 50 nm to 100 μm.

15. The method use-according to claim 14, wherein the particulate mineral-based material combined with a humectant and/or a surfactant provides an increased wettability in combination with a long-lasting effect for a surface on which the liquid foliar composition is applied.

16. The liquid foliar composition according to claim 1, wherein the particulate mineral-based material has
a) a weight-based median particle size d₅₀ value in the range from 50 nm to 200 nm, wherein particles having a weight-based median particle size d₅₀ of ≥1 μm are measured by the sedimentation method and particles having a weight-based median particle size d₅₀ of <1 μm are measured by the dynamic light scattering method, and/or
b) a weight-based top cut d₉₈ in the range from 130 nm to 800 nm, wherein particles having a weight-based median particle size d₅₀ of ≥1 μm are measured by the sedimentation method and particles having a weight-based median particle size d₅₀ of <1 μm are measured by the dynamic light scattering method, and/or
c) a BET specific surface area of from 20 to 100 m²/g, measured using nitrogen and the BET method according to ISO 9277:2010.

17. The liquid foliar composition according to claim 1, wherein
i) the particulate mineral-based material comprises at least one calcium ion-comprising material, selected from the group consisting of natural ground calcium carbonate (NGCC), precipitated calcium carbonate (PCC), hydroxyapatite and mixtures thereof,
ii) the particulate mineral-based material comprises at least one magnesium ion-comprising material, selected from the group consisting of anhydrous magnesium carbonate, magnesium oxide (MgO), artinite (Mg₂(CO₃)(OH)₂·3H₂O), 15 dypingite (Mg₅(CO₃)₄(OH)₂·5H₂O), giorgiosite (Mg₅(CO₃)₄(OH)₂·5H₂O), pokrovskite (Mg₂(CO₃)(OH)₂·5H₂O), barringtonite (MgCO₃·2H₂O), lansfordite (MgCO₃·5H₂O), nesquehonite (MgCO₃·3H₂O), talc (Mg₃Si₄O₁₀(OH)₂) and mixtures thereof, or
iii) the particulate mineral-based material comprises at least one calcium ion-comprising material and at least one magnesium ion-comprising material, selected from the group consisting of dolomite, huntite and mixtures thereof.

18. The liquid foliar composition according to claim 1, wherein the humectant is selected from the group consisting of calcium chloride, potassium nitrate, magnesium sulfate, zinc sulfate, glycerol and mixtures thereof.

19. The liquid foliar composition according to claim 1, wherein the surfactant comprises one or more of:
i) one or more anionic surfactant(s) selected from the group consisting of a salt of fatty acid, a benzoate, an alkylsulfosuccinate, a dialkylsulfosuccinate, a polycarboxylate, a salt of alkylsulfuric acid ester, an alkyl sulfate, an alkyl diglycol ether sulfate, a salt of alcohol sulfuric acid ester, a sulfonate, an alkyldiphenyl ether disulfonate, a polystyrene sulfonate, a phenol sulfonate condensed with formaldehyde, a salt of alkylphosphoric acid ester, an alkylaryl phosphate, a styrylaryl phosphate; a salt of polyoxyethylene alkyl ether sulfuric acid ester, a polyoxyethylene alkylaryl ether sulfate, a polyoxyethylene styrylaryl ether sulfate, an ammonium polyoxyethylene styrylaryl ether sulfate, a salt of polyoxyethylene alkylaryl ether sulfuric acid ester, a polyoxyethylene alkyl ether phosphate, a salt of polyoxyethylene alkylaryl phosphoric acid ester, a polyoxyethylene styrylaryl ether phosphoric acid ester, a salt of polyoxyethylene styrylaryl ether phosphoric acid ester, and a salt of maleic anhydride alkylene copolymer;
ii) one or more nonionic surfactant(s) selected from the group consisting of an organomodified trisiloxane, organosilicone, polyethylene glycol monoether, sorbitan fatty acid ester, a glycerin fatty acid ester, a fatty acid polyglyceride, a fatty acid alcohol polyglycol ether, an acetylene glycol, an acetylene alcohol, an oxyalkylene block polymer, a polyoxyethylene alkyl ether, a polyoxyethylene alkylaryl ether, a polyoxyethylene styrylaryl ether, a polyoxyethylene glycol alkyl ether, a polyoxyethylene fatty acid ester, a polyoxyethylene sorbitan fatty acid ester, a polyoxyethylene sorbitol fatty acid ester, a polyoxyethylene glycerin fatty acid ester, a polyoxyethylene hydrogenated castor oil, a polyoxyethylene castor oil and a polyoxypropylene fatty acid ester; and
iii) one or more cationic surfactant(s) selected from the group consisting of an alkoxylated fatty amine, amphoteric surfactants, and mixtures thereof.

20. The liquid foliar composition according to claim 1, wherein the composition further comprises a dispersing agent, wherein the dispersing agent is made of monomers and/or co-monomers selected from the group consisting of acrylic acid, methacrylic acid, itaconic acid, crotonic acid, fumaric acid, maleic anhydride acid, isocrotonic acid, aconitic acid (cis), aconitic acid (trans), mesaconic acid, sinapinic acid, undecylenic acid, angelic acid, canellic acid, hydroxyacrylic acid, acrolein, acrylamide, acrylonitrile, dimethylaminoethyl methacrylate, vinylpyrrolidone, vinylcaprolactam, ethylene, propylene, isobutylene, diisobutylene, vinyl acetate, styrene, alpha-methyl styrene, methyl vinyl ketone, an ester of acrylic acid, an ester of methacrylic acid, and mixtures thereof.
